(19) United States
(12) Patent Application Publication
(10) Pub. No.: US 2026/0226627 A1
(43) Pub. Date: Aug. 6, 2026

(54) METHOD FOR PREPARING A COMPOSITE AND FORMULATION

(71) Applicant: Merck Patent GmbH, Darmstadt (DE)

(72) Inventors: Oliver Doll, Dietzenbach (DE); Manuel Hamburger, Mannheim (DE); Andreas Berkefeld, Darmstadt (DE); Simon Siemianowski, Rossdorf (DE); Sophia Buhbut, Ashkelon (IL); Stephan Wieder, Frankfurt am Main (DE)

(21) Appl. No.: 19/150,860

(22) PCT Filed: Jan. 30, 2024
(86) PCT No.: PCT/EP2024/052116

§ 371 Date: Jul. 24, 2025

(30) Foreign Application Priority Data
Feb. 1, 2023 (EP) 23154538.5

(51) Int. Cl. C23C 18/12

(52) U.S. Cl. CPC C23C 18/1216

(57) ABSTRACT

The present invention relates to a method for preparing a composite, comprising at least the following steps (a) to (e): (a) providing a formulation onto a surface of a substrate; (b) applying baking at a starting temperature to the formulation; (c) increasing the temperature of the baking from the starting temperature to the 2nd temperature in the range from 100° C. to 400° C.; (d) optionally keeping the 2nd temperature; and (e) terminating the baking to obtain a composite.

### FIELD OF THE INVENTION

The present invention relates to a formulation for preparing an optical layer containing a metal oxide, use of the formulation, use of the formulation as an ink for ink-jetting techniques, method for preparing composite containing a metal oxide with using the formulation, a composite obtained from the method, an optical device and a display device.

### BACKGROUND ART

Leading edge optical devices typically include optical gratings made from composite materials having a substrate as a support and complex and interlaced patterns thereon, the patterns being made up of different layers or stacks of layers. Usually, the creation of such complex and interlaced patterns demands structuring processes, which become increasingly challenging with decreasing size of structural dimensions to be prepared.

In addition to a wide range of possible uses in various fields of application, such as in spectrometers or in optical storage systems (CD, DVD, etc.), diffractive gratings are the core components of so-called XR devices, mostly glasses. In this context, R stands for the term reality and X denotes different attributes such as, for example, virtual, augmented, mixed and so forth. Hence, diffractive gratings form part of the core of the so-called optical engine in XR devices, specifically in augmented reality and mixed reality glasses. Virtual reality glasses, when built as a head mounted display, are often composed of a conventional liquid crystal (LC) organic light emitting diode (OLED) display embedded in the device, and thus do not necessarily require diffractive gratings. In contrast, augmented and mixed reality glasses are designed that way to enable consumers to obtain visual impressions of their environment, at its best as if they would not wear any glasses at all. However, they also make it possible to provide and serve digital information and to also project it into the field of vision of individuals.

Additional digital information is gathered from recognizing and analyzing the environment, the individual inspects or takes a look currently at. In order to convey and project supporting digital information into the eyes of an individual, the augmented or mixed reality glasses are equipped with an information supply unit, which is coupled to an optical waveguide system that transports the optically coded supporting information through it directly to the lens of the glasses. Here, the information passes a diffractive grating which couples the incident light into the lens and splits it according to its angular information and its spectral bands by diffraction. After incoupling of the light, the lens serves as waveguide enabling transport of the light to and into the pupil of an individual. The location of light incoupling is independent of any preferred position and thus of the implication of technical needs. The direction of traversal of light within the lenses is determined by the diffractive grating diffracting or splitting the light. At certain positions in the lens, a second and a third diffractive grating serves for changing the direction of light traversal and thereby enforcing the light to be projected into pupil of the user. The light traversal in the glasses is accomplished by total internal reflection (TIR) of the light, thus bouncing several times between the glass interfaces until reaching another diffractive grating, which changes the internal TIR direction of the light (see FIG. 2). The second and third grating are geometrically aligned in different directions with respect to the first and incoupling grating, e. g. by a certain angular distortion of the longitudinal axis, thus allowing to change the direction of propagation of totally internally reflected light. Needless to say, the lens itself or the material of which lenses are made of shall not be absorbing. Otherwise, the supportive information never reaches the pupil of the user or only with strongly depleted light intensity. The process works regardless of the use of reflection or transmission gratings. Usually, the lenses are equipped with both types of gratings to properly guide the light. It should also be mentioned that there are differences in the optical performance of reflection and transmission gratings, which, however, are of no further interest in the context of the current invention. The basic structure of the gratings is very similar, which is more important at this point.

Nevertheless, there are different designs and structures such as surface relief (SR) or volume phase holographic (VPH) gratings to achieve waveguide. Both types are very similar in appearance. In the simplest case, the gratings are somehow mounted onto the surface of a waveguiding material, here the lens. The grating itself is composed of an array of fine structures, mostly trenches of a first material type Material 01 with a refractive index RI 01, however, not limited thereto. The geometrical shape of the trenches may be manifold, from rectangular, over V-shaped trenches, U-shaped and there like. The width, including structures with different widths, the geometrical form of the trenches, their pitch as well as their depth, including different depths, are specially designed to influence the diffraction pattern of the incident light to be diffracted.

In case of SR gratings, the trenches or structures of a first material type (Material 01) having a refractive index (RI 01) are filled by a second material type (Material 02) having a refractive index (RI 02), wherein RI 02 is incrementally different from RI 01 (see FIGS. 1 and 3). For the sake of completeness, it should be mentioned that Material 01 or Material 02 may be composed of a stack of structured layers, each containing a different material composition with different refractive index, stacked on top of each other, thereby forming Material 01 or Material 02 having an effective or graded refractive index RI 01 or RI 02, respectively. Incidentally, the (effective or graded) refractive indices RI 01 and RI 02 depend on the refractive index of the waveguide or the lens from which the glasses are made of. If a glass lens with high refractive index (n03>1.46) is used, the (effective or graded) refractive indices of Material 01 and Material 02 are considered to be higher than that of the lens itself, whereby a RI value of 2.0 can be reached and exceeded. High performance gratings, especially those of SRG-type, may be manufactured using standard lithography and deposition techniques known from micro-fabrication such as, for example, the manufacturing of integrated circuits.

Such standard techniques typically include physical vapor deposition (PVD) or chemical vapor deposition (CVD) processes and often suffer from incomplete gap filling due to unfavourable deposition and/or layer growth deposition properties including increased deposition and/or growth rates at corners and edges. Such incomplete gap filling results in the formation of voids within the structures to be filled by the PVD- and CVD-materials. In addition to the formation of voids, the surface of the substrate is covered by a PVD and/or CVD layer that is almost as thick as the maximum depth of the deepest structure to be filled by the deposited gap filling material (see FIGS. 4 and 5). In some applications, however, it may be necessary to expose the surface of the substrate so that it is available for further processing. Therefore, undesired overburden layers from PVD or CVD need to be removed, for example by chemical mechanical planarization (CMP) without harming the original substrate surface underneath. Although CMP is very well established in the process of manufacturing integrated circuits, CMP is a time consuming and costly process and can be seen as a potential economic drawback for mass production of leading-edge optical devices, particularly the mass production of diffractive gratings. It would therefore be desirable to have a solution for an advanced and cost-efficient manufacturing of optical gratings where gap filling does not require CMP (see FIG. 6).

For that reason, more cost-effective production technology allowing for lower cost of ownership is required.

### SUMMARY OF THE INVENTION

Wet deposition process, especially printing is considered as a highly cost efficient production step. Thus, printing the structures or in the case depicted here, the fill up of cavities and structures, demands for formulations of materials being composed as inks, simply spoken e. g. printable high refractive index materials or printable metal oxides. Formulations of metal oxides or printable metal oxides are composed of a solvent or a blend of solvents in which the metal oxide or the respective precursor of a metal oxide is dissolved and stable to premature separation in form of bulk material that results in the clogging of equipment for printing. However, in most cases, the high refractive index metal oxides will be not soluble in formulations and unless suspensions of metal oxide particles are not desirable to become used, the appropriate metal oxide precursors need to become dissolved and kept stable in the formulations. After printing, deposition and fill up of structures, the metal oxide precursors need to become converted into the respective metal oxides by any known means known to the persons skilled in the art (thermally, photochemically, etc.).

Thus, the inventors newly have found that there are still one or more of considerable problems for which improvement is desired, as listed below: providing a printable formulation for preparing an optical layer/composite containing a material which provide sufficiently high refractive indices after curing; providing a formulation of reactive building blocks for preparing an optical layer which enable to prepare a dense and crack-less or crack-free optical layer, enable to fill up of cavities, trenches or gaps after curing; providing a formulation for preparing an optical layer containing a reactive precursor material of a high refractive index material, which disperses well in the formulation; simpler and/or cost-efficient method for preparing an optical layer/composite with using the formulation; realizing no or less occurrence of the mechanical stress, e. g. volume shrinkage, when provided formulation is converted to an optical layer/composite; providing a new method for preparing a composite to realize a high RI value, good gap filling properties of a composite.

The inventors aimed to solve one or more of the above-mentioned problems.

Then, the present inventors have surprisingly found that one or more of the above-described technical problems can be solved by the features as defined in the claims.

Namely, it is found a novel method for preparing a composite with using the formulation as defined below, preferably said composite being a layered composite, more preferably it is an optical layer; said novel method comprises at least the following steps (a) to (e), preferably in the sequence (a) to (e):
(a) providing a formulation onto a surface of a substrate to prepare a coated substrate, preferably by wet deposition process, more preferably by ink-jetting;
(b) applying baking at a starting temperature to the coated substrate;
(c) increasing the temperature of the baking from the starting temperature to the 2^{nd} temperature in the range from 100° C. to 400° C.;
(d) optionally keeping the 2^{nd} temperature; and
(e) terminating the baking to obtain a composite, preferably by stopping heating, by removing the substrate from the heat source or by removing a heat source from the substrate;
wherein said formulation provided in step (a) contains at least one metal halide represented by any one of following formulae (I) to (V) as the 1^{st} metal halide; and at least one solvent.

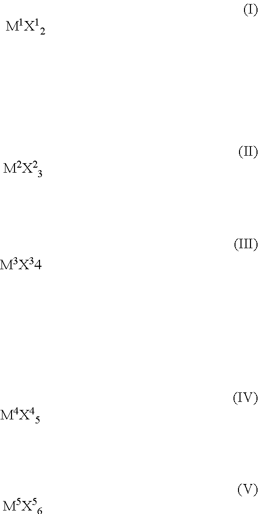

wherein M¹ is a divalent metal selected from Zn or Sn;
M² is a trivalent metal selected from Bi;
M³ is a quadrivalent metal selected from Ti, Zr or Hf;
M⁴ is a pentavalent metal selected from V, Nb or Ta;
M⁵ is Mo or W; and
X¹, X², X³, X⁴, X⁵, X⁶ are each independently a halogen, preferably X¹, X², X³, X⁴, X⁵, X⁶ are each independently selected from F, Cl, Br, I, more preferably X¹, X², X³, X⁴, X⁵, X⁶ are Cl.

In another aspect, the present invention further relates to a composite, preferably being a layered composite, preferably said layered composite is an optical layer, obtained or obtainable by the method of the present invention.

In another aspect, the present invention relates to an optical device comprising the composite of the present invention, and a substrate comprising a patterned surface or an uneven surface having a gap or a trench.

In another aspect, the present invention relates to a display device comprising at least one functional medium configured to direct and modulate light or configured to emit light; and the composite of the present invention, or an optical device of the present invention.

In another aspect, the present invention relates to use of a formulation comprising at least one metal halide represented by any one of following formulae (I) to (V) as the 1^{st} metal halide; and at least one solvent; for preparing a composite in a process comprising at least the following steps (a) to (e), preferably in the sequence (a) to (e):
(a) providing a formulation onto a surface of a substrate to prepare a coated substrate, preferably by wet deposition process, more preferably by ink-jetting;
(b) applying baking at a starting temperature to the coated substrate;
(c) increasing the temperature of the baking from the starting temperature to the 2^{nd} temperature in the range from 100° C. to 400° C.;
(d) optionally keeping the 2^{nd} temperature; and
(e) terminating the baking to obtain a composite, preferably by stopping heating, by removing the substrate from the heat source or by removing a heat source from the substrate;

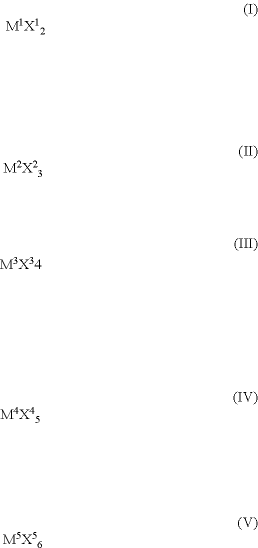

wherein M¹ is a divalent metal selected from Zn or Sn;
M² is a trivalent metal selected from Bi;
M³ is a quadrivalent metal selected from Ti, Zr or Hf;
M⁴ is a pentavalent metal selected from V, Nb or Ta;
M⁵ is Mo or W; and
X¹, X², X³, X⁴, X⁵, X⁶ are each independently a halogen, preferably X¹, X², X³, X⁴, X⁵, X⁶ are each independently selected from F, Cl, Br, I, more preferably X¹, X², X³, X⁴, X⁵, X⁶ are Cl;
wherein the solvent is an organic solvent.

In another aspect, the present invention also relates to a novel formulation for preparing an optical layer containing a metal oxide, preferably for preparing a composite, more preferably for preparing a layered composite, comprising at least, or mainly consisting of, or consisting of;
(i) at least one metal halide as a precursor; and
(ii) at least one solvent containing at least one hydroxy group, preferably the viscosity of the said solvent is 50 mPas or less, preferably the boiling point of the another solvent at 1 atm is 140° C. or more and 300° C. or less.

The viscosity of the inks and solvents according to the present invention is measured with a 1° cone-plate rotational rheometer of the System Haake Mars III (Cone-plate type from Thermo Scientific). The equipment allows precise control of the temperature and sheer rate. The measurement of the viscosity is carried out at a temperature of 25.0° C. (+/−0.2° C.) and a sheer rate of 500 s-1. Each sample is measured three times, then the obtained measured values are averaged.

These boiling points can be found in publicly available literature/chemical databases. These boiling points may also be measured by the method of ISO 4626: 2023 (EN).

In another aspect, the present invention also relates to use of the formulation of the present invention for preparing an optical layer containing a metal oxide. Namely, use of the formulation as an ink for ink-jetting techniques,

In another aspect, the present invention further relates to method for preparing a composite containing a metal oxide, preferably said metal oxide is selected from metal dioxide, metal mono oxide, or a combination of these; comprising the following steps (a) and (b):
(a) providing the formulation of the present invention onto a surface of a substrate, preferably by printing, more preferably by spin-coating or ink-jetting, even more preferably by ink-jetting; and
(b) applying a thermal treatment to the formulation provided on the surface of the substrate to convert at least a part of the metal halide of the formulation to a metal oxide.

In another aspect, the present invention further relates to the composite obtained or obtainable by the method of the present invention.

In another aspect, the present invention also relates to an optical device comprising the composite of the present invention, and a patterned substrate comprising topographical features on the surface thereof.

In another aspect, the present invention further relates to a display device comprising at least one functional medium configured to modulate a light or configured to emit light; and the composite of the present invention, or an optical device of the preset invention.

### Technical Effects of the Invention

The present invention may provide one or more of following effects;
providing a printable formulation for preparing an optical layer/composite containing a material which provide sufficiently high refractive indices after curing; providing a formulation for preparing an optical layer which enable to prepare a dense and crack-less or crack-free optical layer, enable to fill up of cavities, trenches or gaps more efficiently after curing;
providing a formulation for preparing an optical layer containing a precursor material of a high refractive index material, which well disperses in the formulation; simpler and/or cost-efficient method for preparing an optical layer/composite with using the formulation; realizing no or less occurrence of the mechanical stress, e. g. volume shrinkage, when provided formulation is converted to an optical layer/composite; providing a new method for preparing a composite to realize a high RI value, good gap filling properties of a composite.

Preferred embodiments of the present invention are described hereinafter and in the dependent claims.

### BRIEF DESCRIPTION OF THE FIGURES

FIG. 1: Schematic cross-sectional view of a SRG grating with a Material 01 and a Material 02, wherein the refractive index IR 01 of Material 01 is incrementally different to the refractive index IR 02 of Material 02.

FIG. 2: Schematic cross-sectional view of a SRG grating enabling light diffraction (transmissive case) including propagation of diffracted light within waveguide (e.g. lens) by total internal reflection.

FIG. 3: Schematic cross-sectional view of a SRG grating providing gaps (trenches) to be filled with a high refractive index material (Material 02), wherein the refractive index of Material 02 is incrementally different form the refractive index of Material 01 flanking the gaps (trenches).

FIG. 4: Schematic representation of PVD- or CVD-mediated gap filling process and removal of undesired overburden.

FIG. 5: Schematic representation of PVD- or CVD-mediated gap filling process creating and leaving voids within gaps and deposited layers.

FIG. 6: Schematic representation of gap filling process using formulations containing inventive metal complex or formulations thereof being converted to metal oxides.

FIG. 7: SEM cross-sectional view of an array of trenches after layer coating, followed by pre-baking and baking as described in Example 4 (the nominal cross-sectional opening width of the trenches is 150 nm).

FIG. 8: SEM cross-sectional view of an array of trenches after layer coating, followed by pre-baking and baking as described in Example 5 (the nominal cross-sectional opening width of the trenches is 150 nm).

FIG. 9: SEM cross-sectional view of an array of trenches after layer coating, followed by pre-baking and baking as described in Example 6 (the nominal cross-sectional opening width of the trenches is 150 nm).

FIG. 10: SEM cross-sectional view of an array of trenches after layer coating, followed by pre-baking and baking as described in Example 7 (the nominal cross-sectional opening width of the trenches is 150 nm).

FIG. 11: Graph of Dynamic Viscosity value change during storage in Example 7.

FIG. 12: SEM cross-sectional view of an array of trenches after layer coating, followed by pre-baking and baking as described in Example 10.

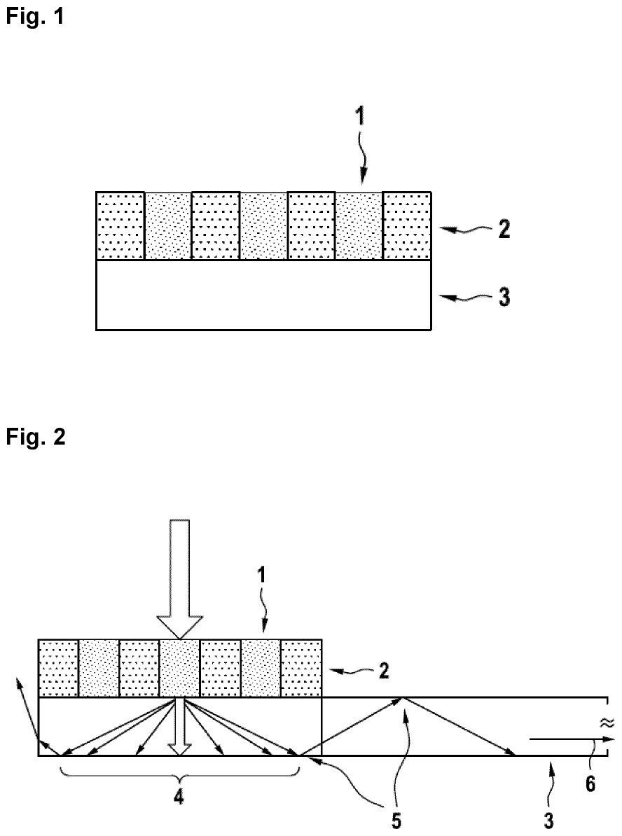

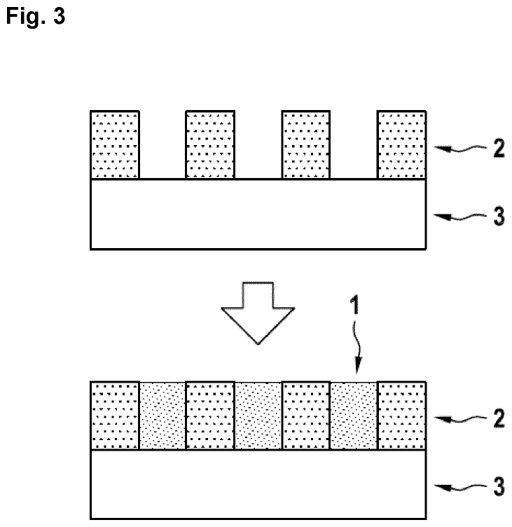

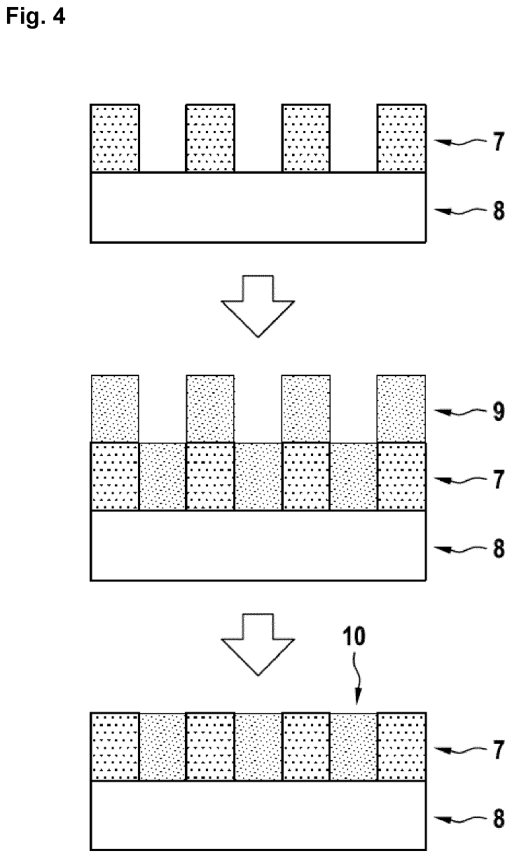

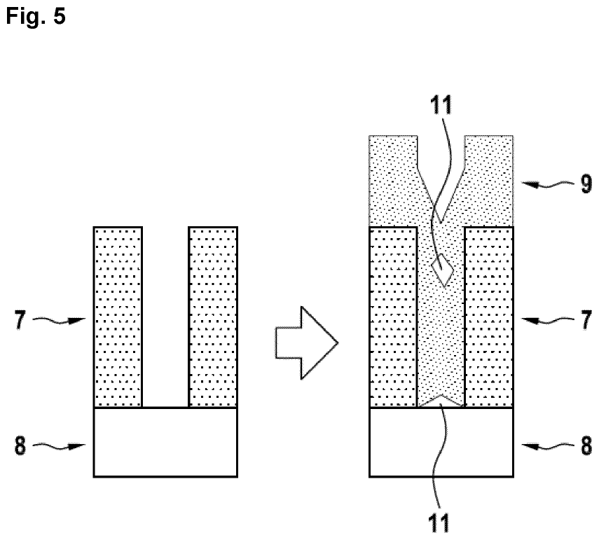

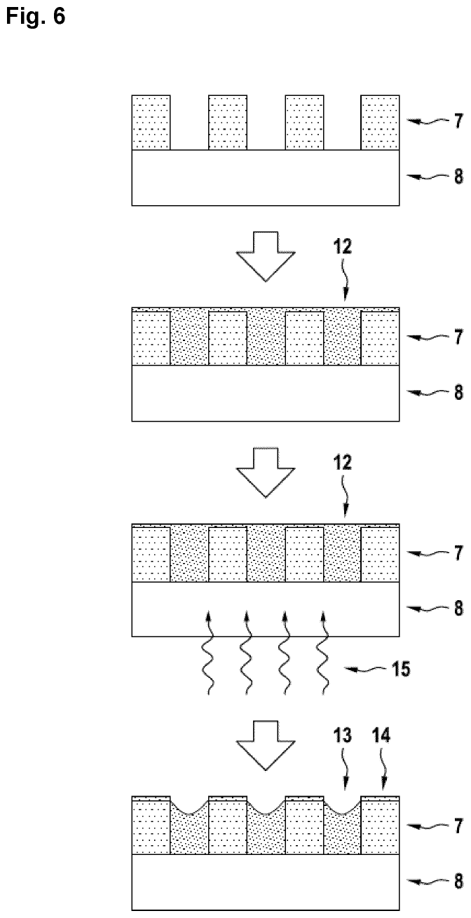

### LIST OF REFERENCE SIGNS

1. Material 02 with RI 02
2. Material 01 with RI 01
3. Substrate (e. g. glass)
4. Diffraction of incident light represented by broad arrow
5. Total internal reflection of light (TIR)
6. Waveguide
7. Structured layer stack with gaps (trenches)
8. Substrate (e. g. glass or silicon)
9. Overburden of material (e. g. high refractive index material or high etch resistant material)
10. Material (e. g. high refractive index material or high etch resistant material) providing gap fill
11. Voids
12. Formulation (e. g. ink) of high refractive index material (e. g. metal oxide precursor)
13. High refractive index material (e. g. metal oxide) providing gap fill with optional concave geometry
14. Overburden layer (optional)
15. Energy

### Definition of the Terms

The term “surfactant” as used herein, refers to an additive that reduces the surface tension of a given formulation.

The term “wetting and dispersion agent” as used herein, refers to an additive that increases the spreading and penetrating properties of a given formulation. In this way, the tendency of the molecules to adhere to each other is reduced.

The term “adhesion promoter” as used herein, refers to an additive that increases the adhesion of a given formulation.

The term “polymer matrix” as used herein, refers to an additive that acts as a macromolecular matrix for one or more components of a given formulation.

The term “optical device” as used herein, relates to a device containing one or more optical components for forming a light beam including, but not limited to, gratings, lenses, prisms, mirrors, optical windows, filters, polarizing optics, UV and IR optics, and optical coatings. Preferred optical devices in the context of the present invention are augmented reality (AR) glasses and/or virtual reality (VR) glasses.

The term “display device” as used herein, is a kind of an optical device configured to output/present information in visual or tactile form. Examples are Liquid crystal display (LCD), Light emitting diode display (LED display), organic light emitting display (OLED), micro LED display, quantum dot display (QLED), AR/VR display, plasma (PDP) display, electroluminescent (ELD) display.

### DETAILED DESCRIPTION OF THE INVENTION

According to the present invention, in one aspect, it relates to method for preparing a composite, preferably said composite being a layered composite, more preferably it is an optical layer; comprising at least the following steps (a) to (e), preferably in the sequence (a) to (e):
(a) providing a formulation onto a surface of a substrate to prepare a coated substrate, preferably by wet deposition process, more preferably by ink-jetting;
(b) applying baking at a starting temperature to the coated substrate;
(c) increasing the temperature of the baking from the starting temperature to the 2^{nd} temperature in the range from 100° C. to 400° C.;
(d) optionally keeping the 2^{nd} temperature; and
(e) terminating the baking to obtain a composite, preferably by stopping heating, by removing the substrate from the heat source or by removing a heat source from the substrate;
wherein said formulation provided in step (a) contains at least one metal halide represented by any one of following formulae (I) to (V) as the 1^{st} metal halide; and at least one solvent.

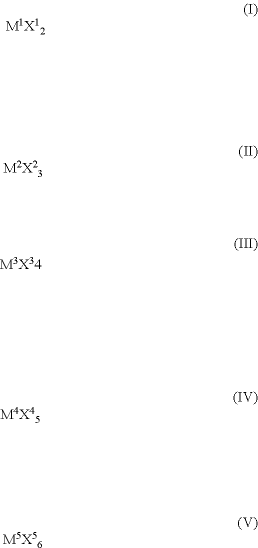

wherein M¹ is a divalent metal selected from Zn or Sn;
M² is a trivalent metal selected from Bi;
M³ is a quadrivalent metal selected from Ti, Zr or Hf;
M⁴ is a pentavalent metal selected from V, Nb or Ta;
M⁵ is Mo or W; and
X¹, X², X³, X⁴, X⁵, X⁶ are each independently a halogen, preferably X¹, X², X³, X⁴, X⁵, X⁶ are each independently selected from F, Cl, Br, I, more preferably X¹, X², X³, X⁴, X⁵, X⁶ are Cl.

It is believed said ink-jetting to provide said formulation may realize improved gap filling property.

In a preferred embodiment of the present invention, the formulation further contains another metal halide as the 2^{nd} metal halide represented by any one of the formulae (I′) to (V′);

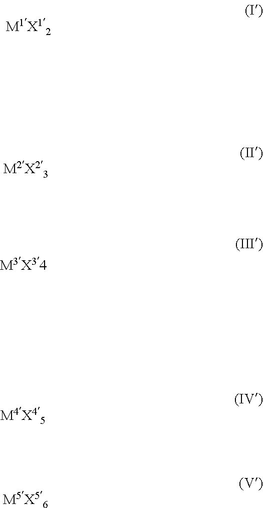

wherein M¹′ is a divalent metal, preferably M¹′ is selected from Zn;
M²′ is a trivalent metal selected from Bi;
M³′ is a quadrivalent metal selected from Ti, Zr or Hf;
M⁴′ is a pentavalent metal selected from V, Nb or Ta;
M⁵′ is Mo or W; and
X¹′, X²′, X³′, X⁴′, X⁵′, X⁶′ are each independently a halogen, preferably X¹′, X²′, X³′, X⁴′, X⁵′, X⁶′ are each independently selected from F, Cl, Br, I, more preferably X¹′, X²′, X³′, X⁴′, X⁵′, X⁶′ are Cl; and
said 1^{st} metal halide and the 2^{nd} metal halide are different of each other; and
the weight ratio of the 2^{nd} metal halide to the 1^{st} metal halide is less than 1, preferably in the range from 0.01 to 0.99. Preferably the total content of the 2^{nd} metal halide based on the total mass of the 1^{st} metal halide is in the range from 0.1 to 99.9 wt %.

Preferably, the total content of all metal halide(s) in the formulation is in the range from 0.1 w % to 50 w % based on the total mass of the formulation, preferably it is from 1 wt. % to 30 wt. %, more preferably from 5 to 20 wt. %.

According to the present invention, preferably, the solvent is an organic solvent. Preferably said organic solvent is selected from one or more members of the group consisting of ethylene glycol monoalkyl ethers, preferably it is ethylene glycol monomethyl ether, ethylene glycol monoethyl ether, ethylene glycol monopropyl ether and/or ethylene glycol monobutyl ether; diethylene glycol dialkyl ethers, preferably it is diethylene glycol dimethyl ether, diethylene glycol diethyl ether, diethylene glycol dipropyl ether and/or diethylene glycol dibutyl ether; propylene glycol monoalkyl ethers, preferably it is propylene glycol monomethyl ether (PGME), propylene glycol monoethyl ether and/or propylene glycol monopropyl ether; ethylene glycol alkyl ether acetates, preferably it is methyl cellosolve acetate and/or ethyl cellosolve acetate; propylene glycol alkyl ether acetates, preferably it is propylene glycol monomethyl ether acetate (PGMEA), propylene glycol monoethyl ether acetate and/or propylene glycol monopropyl ether acetate; ketones, preferably it is methyl ethyl ketone, acetone, methyl amyl ketone, methyl isobutyl ketone and/or cyclohexanone; alcohols, preferably it is ethanol, propanol, 1,3-dimethoxy-2-propanol, butanol, hexanol, cyclo hexanol, ethylene glycol, propylene glycol, triethylene glycol, glycerin, pentanols, preferably it is 1-pentanol, 2-pentnol, 3-pentanol, 3-ethyl-3-pentanol, 2,4-dimethyl-3-pentanol; esters, preferably it is ethyl 3-ethoxypropionate, methyl 3-methoxypropionate and/or ethyl lactate; and cyclic esters, preferably it is gamma-butyro-lactone; preferably said solvent is selected from propylene glycol alkyl ether acetates, ethylene glycol monoalkyl ethers, propylene glycol and propylene glycol monoalkyl ethers, 1-pentanol, 2-pentnol, 3-pentanol, 3-ethyl-3-pentanol, 2,4-dimethyl-3-pentanol 1,3-dimethoxy-2-propanol or a mixture of any one of them.

Further preferably, said solvent contains at least 1,3-dimethoxy-2-propanol. Thus, in a preferred embodiment, said solvent may be 1,3-dimethoxy-2-propanol only or a mixture of 1,3-dimethoxy-2-propanol and another solvent selected from any one or more of above mentioned solvents.

In a preferred embodiment of the present invention, the metal halide of the formulation is represented by any one of following formulae (I) and the solvent contains at least 1,3-dimethoxy-2-propanol.

It is believed that these solvents, namely 1,3-dimethoxy-2-propanol is preferable solvent for realizing improved dispersibility of metal chloride precursor in the formulation, improved stability of formulation, improved stability of formulation under the conditions of deposition by ink-jetting, particularly ink-jetting under ambient atmosphere, realizing dense and crack-less layer, improving filling up properties of formulation for nanosized cavities.

In a preferred embodiment of the present invention, the formulation contains tripropylene glycol in addition to the above-mentioned solvent. It is believed that said tripropylene glycol may augment the formation of a homogeneous liquid film from dispensed ink droplets and improved gap fill such as seamless gapfill without causing any adverse effect on the printing equipment and no change in reflactive index value of the obtained layer.

It is more preferable that the formulation of the present invention contains at least 1,3-dimethoxy-2-propanol as a solvent and further contains tripropylene glycol. It is believed that tripropylene glycol shows more improved gap fill such as flawless gap fill when it is mixed with 1,3-dimethoxy-2-propanol, augments the deposition of a homogeneous liquid film from ink droplets preferably without causing defects of the printing equipment and no change in refractive index value of the obtained layer.

Preferably, the temperature of the baking in step (c) is increased to the temperature in the range from 100° C. to 400° C., preferably it is in the range from 170 to 250° C., more preferably from 190 to 230° C.

In a preferred embodiment, the temperature of the post bake in St©(c) is increased at the temperature increasing rate in the range from 1° C./min to 20° C./min, preferably in the range from 2° C./min to 15° C./min, even more preferably from 3° C./min to 10° C./min.

Preferably, the substrate used in the method has a patterned surface or an uneven surface having a gap or a trench. Preferably said substrate is a patterned substrate comprising topographical features on the surface thereof.

In a preferred embodiment of the present invention, baking step (b) is applied without any delay after completion of step (a). Preferably steps (a) and (b) are performed continuously.

It is desirable to apply baking step (b) within 5 min after completion of step (a), more preferably within 1 min.

It is considered as pivotal that the interaction of the printed formulation (wet film shape) with the atmosphere via mass transport across liquid/gas interface is affected/controlled in an effective way by applying thermal treatment (baking step (b)) shortly step (a) without delay. And it may realize improved gap fill property.

In some embodiments, when a large area of substrate is applied to step (a), already printed part (the area where the formulation is already provided onto a part of the surface of a substrate) of the substrate may be subjected to step (b) while step (a) is still applied to the other part of the substrate where the formulation is not yet provided.

Then, the present invention also relates to a composite, preferably being of a layered composite, preferably said layered composite is an optical layer, obtained or obtainable by the above mentioned method for preparing a composite, preferably said composite being a layered composite, more preferably it is an optical layer; comprising at least the following steps (a) to (e), preferably in the sequence (a) to (e).

In a preferred embodiment of the present invention, said composite comprises at least one metal halide, and a metal oxide derived from said metal halide. Preferably said metal halide is the 1^{st} metal halide. More preferably, the composite further comprises the 2^{nd} metal halide and a metal oxide derived from the 2^{nd} metal halide.

Then, the present invention also relates to an optical device comprising a composite, obtained or obtainable by the above-mentioned method; and a substrate comprising a patterned surface or an uneven surface having a gap or a trench. Preferably a gap or trench of said patterned surface or an uneven surface of the substrate is at least partly filled with said composite. Preferably said substrate is a patterned substrate comprising topographical features on the surface thereof. Preferably said composite fills at least a part of a gap of said topographical features, more preferably said composite fills a trench of the patterned substrate. It is preferred that the optical device is an augmented reality (AR) and/or virtual reality (VR) device.

The present invention further relates to a display device comprising at least one functional medium configured to direct and modulate light or configured to emit light; and the composite of the present invention described above, or an optical device mentioned above. Preferably said display device is selected from Liquid crystal display (LCD), Light emitting diode display (LED display), organic light emitting display (OLED), micro LED display, quantum dot display (QLED), AR/VR display, plasma (PDP) display, or an electroluminescent (ELD) display.

In another aspect, the present invention may relate to a formulation for preparing an optical layer containing a metal oxide, preferably for preparing a composite, more preferably for preparing a layered composite, comprising, essentially consisting of or consisting of;
(i) at least one metal halide as a precursor; and
(ii) at least one solvent containing at least one hydroxy group, preferably the viscosity of the said solvent is 50 mPas or less, preferably the boiling point of the another solvent at 1 atm is 140° C. or more and 300° C. or less.

### Metal Halide Precursor

According to the present invention when it relates to the formulation as described above, said metal halide precursor includes anhydrous metal halides and hydrous metal halides, e. g. SnCl₂*H₂O.

Thus, in a preferred embodiment of the present invention, said metal halide is anhydrous metal halide or hydrous metal halide, wherein said metal halide of anhydrous metal halide/hydrous metal halide is represented by MX₂;
wherein M is a divalent metal, preferably M is group 14 element of the periodic table, more preferably it is selected from Ge, Sn and Pb, furthermore preferably it is Sn; and
X is a halogen, preferably it is selected from F, Cl, Br, I, At, more preferably X is Cl.

Preferably, the content of the metal halide in the formulation is in the range from 0.1% to 50% (w/w), based on the total mass of the formulation, preferably it is from 1 wt % to 25 wt %, more preferably from 5 to 15 wt %. Here, when anhydrous metal halide is used, the total content of anhydrous metal halide in the formulation is preferably in the above-mentioned range.

It is believed that the metal halides of the present invention provides adjustable refractive index value when it is used in the formulation for preparing an optical layer, meaning that the refractive index value of an optical layer/composite made from the composition can be controlled by adding said metal halides as a precursor, preferably it further realizes a lower parasitic absorption of an optical layer/composite made from the formulation.

It is also believed that said metal halides of the present invention can be well dispersed or dissolved in a formulation and it is preferable for wet deposition process.

### Solvent

In a preferred embodiment of the present invention when it relates to the formulation as described above, said solvent is selected from alcohols, carboxylic acids from the viewpoint of realizing wet deposition process, namely inkjettable formulation. It is believed that the solvent of the present invention leads more homogeneous, dense, crack-less and/or crack-free optical layer/composite. Preferably it also reads improved gap fill of nano-scaled cavities, trenches.

It is believed that the printing, especially inkjetting of structures is considered as a highly cost-efficient production step. Thus, suitable solvents of the formulation for printing the structures or filling up of cavities and structures, is described here.

Formulations of metal oxides or printable metal oxides are usually composed of a solvent or a blend of solvents in which the respective precursor of a metal oxide is dissolved. However, in most cases, the high refractive index metal oxides are not soluble in formulations and unless suspension of metal oxide particles are not desirable to become used.

Thus, according to the present invention, the metal halide is used as a metal oxide precursor in the formulation together with a solvent containing at least one hydroxy group, or in the formulation together with a co-solvent containing at least the solvent containing at least one hydroxy group and another solvent.

After printing, deposition and fill up of structures, at least a part of the metal oxide precursors needs to become converted into the respective metal oxides by any known means known to the persons skilled in the art (thermally, photochemically, etc.).

Thus, in a preferred embodiment of the present invention, said solvent is selected from alcohols, more preferably it is methanol, Hydroxyacetone, 3,3-dimethyl-2-butanol, ethanol amine, cyclopentanol, 1,3-dimethoxy-2-propanol, diethyleneglycol monohexyl ether, dipropyleneglycol monobutyl ether, or a combination of any of these from the viewpoint of leading more homogeneous, dense, crack-less and/or crack-free optical layer/composite and/or improved gap fill of nano-scaled cavities, trenches.

Even more preferably, Hydroxyacetone, ethanol amine, cyclopentanol, 1,3-dimethoxy-2-propanol or a combination of any of these, furthermore preferably Hydroxyacetone or 1,3-dimethoxy-2-propanol from the above-mentioned viewpoint. It is believed the above-mentioned selected solvents are particularly preferable one to be used in the formulation containing the metal halide as a precursor of the present invention to show one or more of the above-mentioned technical effects.

It is believed that the combination of the metal halide precursor and said solvent leads to a conversion of the metal halide precursor without or less occurrence of the conversion related mechanical stress, e. g. volume shrinkage.

In a preferred embodiment of the present invention, the formulation contains tripropylene glycol in addition to the above-mentioned solvent. It is believed that said tripropylene glycol may realize an improved gap fill such as flawless gap fill, preferably without causing printing issue and no change in Refractive index value of the obtained layer.

It is more preferable that the formulation of the present invention contains at least said 1,3-dimethoxy-2-propanol as a solvent and further contains tripropylene glycol. It is believed that tripropylene glycol shows more improved gap fill such as flawless gap fill when it is mixed with 1,3-dimethoxy-2-propanol, preferably without causing printing issue and no change in Refractive index value of the obtained layer.

In some embodiment of the present invention, the formulation may optionally contain at least one another solvent to form a co-solvent together with the solvent described above. Preferably the viscosity of the said another solvent is 50 mPas or less, preferably the boiling point of the another solvent at 1 atm is 140° C. or more and 300° C. or less.

In a preferred embodiment, said another solvent has at least one hydroxy group. More preferably, said another solvent is selected from alcohols, carboxylic acids like described in the solvent above. When said co-solvent containing at least the solvent having at least one hydroxy group and said another solvent having at least one hydroxy group, is used in the formulation, each solvent of the co-solvent is preferably selected from alcohols, more preferably it is methanol, Hydroxyacetone, 3,3-dimethyl-2-butanol, ethanol amine, cyclopentanol, 1,3-dimethoxy-2-propanol, diethyleneglycol monohexyl ether, dipropyleneglycol monobutyl ether, or a combination of any of these, even more preferably Hydroxyacetone, ethanol amine, cyclopentanol, 1,3-dimethoxy-2-propanol or a combination of any of these, furthermore preferably Hydroxyacetone or 1,3-dimethoxy-2-propanol.

### Additives

In some embodiment of the present invention when it relates to the formulation as described above, the formulation further comprises (iii) one or more additives selected from surfactants, wetting and dispersion agents, adhesion promoters, and polymer matrices. In some embodiments, said formulation may not include any additive described here.

Preferred surfactants are surface active substances, which preferably include surface active metal oxides and/or surface-active organic compounds. Surface-active organic compounds may include nonionic surfactants, anionic surfactants, and ampholytic surfactants and they may be coordinating or non-coordinating.

Examples of nonionic surfactants include, polyoxyethylene alkyl ethers, such as polyoxyethylene lauryl ether, polyoxyethylene oleyl ether and polyoxyethylene cetyl ether; polyoxyethylene fatty acid diester; polyoxyethylene fatty acid monoester; polyoxyethylene polyoxypropylene block polymer; acetylene alcohol; acetylene glycol; polyethoxylate of acetylene alcohol; acetylene glycol derivatives, such as polyethoxylate of acetylene glycol; fluorine-containing surfactants, for example, FLUORAD (trade name, manufactured by Sumitomo 3M Limited), MEGAFAC (trade name: manufactured by DIC Cooperation), SURFLON (trade name, 5 manufactured by Asahi Glass Co. Ltd); or organosiloxane surfactants, for example, KP341 (trade name, manufactured by Shin-Etsu Chemical Co., Ltd.), and the like. Examples of said acetylene glycol include 3-methyl-1-butyne-3-ol, 3-methyl-1-pentyn-3-ol, 3,6-dimethyl-4-octyne-3,6-diol, 2,4,7,9-tetramethyl-5-decyne-4,7-diol, 3,5-dimethyl-1-hexyne-3-ol, 2,5-dimethyl-3-10 hexyne-2,5-diol, 2,5-dimethyl-2,5-hexane-diol, and the like.

Examples of anionic surfactants include organic amine salt of alkyl diphenyl ether disulfonic acid, organic amine salt of alkyl diphenyl ether sulfonic acid, organic amine 15 salt of alkyl benzene sulfonic acid, organic amine salt of polyoxyethylene alkyl ether sulfuric acid, organic amine salt of alkyl sulfuric acid, and the like.

Examples of amphoteric surfactants include 2-alkyl-N-carboxymethyl-N-20 hydroxyethyl imidazolium betaine, lauric acid amide propyl hydroxysulfone betaine, and the like.

Preferred surface-active metal oxides are selected from the list consisting of aluminum oxide, calcium oxide, silica, and zinc oxide. Such surface-active metal oxides are preferably present as fine powders, more preferably as nanoparticles, which are optionally surface treated.

Preferred surface-active organic compounds are surface-active non-polymeric compounds or surface-active polymeric organic compounds, wherein said surface-active non-polymeric compounds are preferably selected from the list consisting of alcohols, alkoxylates, aromatics, ketones, esters, modified urea, silanes, siloxanes and soap-based foam stabilizers, which are optionally functionalized and/or modified; and wherein said surface-active polymeric compounds are preferably selected from the list consisting of hydroxy polyesters, maleinate resins, polyacrylates, polyethers, polyester, polysilanes, silicone resins, and waxes, which are optionally functionalized and/or modified; and which are optionally present as copolymers. In a preferred embodiment, the surface-active organic compound is used as a solution.

Preferred silanes are polyether-modified silanes, polyester-modified silanes, and polyether-polyester-modified silanes. Preferred siloxanes are polyether-modified siloxanes, polyester-modified siloxanes, and polyether-polyester-modified siloxanes.

Preferred polyacrylates are modified polyacrylates, preferably silicone-modified polyacrylates, polyether macromer-modified polyacrylates, and silicone and polyether macromer-modified polyacrylates, which are optionally present as copolymers.

Preferred polysilanes are polyether-modified polysilanes (e. g. PEG-Silane 6-9), polyester-modified polysilanes, and polyether-polyester-modified polysilanes.

Preferred silicone resins are polyether-modified polysiloxanes, preferably polyether-modified polydialkylsiloxanes, more preferably polyether-modified polymethylalkylsiloxanes, and most preferably polyether-modified polydimethylsiloxanes and polyether-modified, hydroxy-functional polydimethylsiloxanes; polyester-modified polysiloxanes, preferably polydialkylsiloxanes, more preferably polyester-modified polymethylalkylsiloxanes, and most preferably polyester-modified polydimethylsiloxanes and polyester-modified, hydroxy-functional polydimethylsiloxanes; polyether-polyester-modified polysiloxanes, preferably polyether-polyester-modified polydialkylsiloxanes, more preferably polyether-polyester-modified polymethylalkylsiloxanes, and most preferably polyether-polyester-modified polydimethylsiloxanes and polyether-polyester-modified, hydroxy-functional polydimethylsiloxanes; epoxy functional polysiloxanes, preferably epoxy functional polydialkylsiloxanes, more preferably epoxy functional polymethylalkylsiloxanes, and most preferably epoxy functional polydimethylsiloxanes; acryl functional polysiloxanes, preferably acryl functional polydialkylsiloxanes, more preferably acryl functional polymethylalkylsiloxanes, and most preferably acryl functional polydimethylsiloxanes; polyether-modified, acryl functional polysiloxanes, preferably polyether-modified, acryl-functional polydialkylsiloxanes, more preferably polyether-modified, acryl-functional polymethylalkylsiloxanes, and most preferably polyether-modified, acryl-functional polydimethylsiloxanes; polyester-modified, acryl-functional polysiloxanes, preferably polyester-modified, acryl-functional polydialkylsiloxanes, more preferably polyester-modified, acryl-functional polymethylalkylsiloxanes, and most preferably polyester-modified, acryl-functional polydimethylsiloxanes; and aralkyl-modified polysiloxanes, preferably aralkyl-modified or alkylaryl-modified polydialkylsiloxanes, more preferably aralkyl-modified polymethylalkylsiloxanes, and most preferably aralkyl-modified polydimethylsiloxanes; which are optionally present as copolymers.

Preferred surfactants are commercially available from BYK-Chemie GmbH, Wesel, Germany and offered as surface additives. Preferred surfactants are DISPERBYK (hereafter “BYK”) surfactants selected from BYK-300, BYK-301, BYK-302, BYK-306, BYK-307, BYK-310, BYK-313, BYK-315 N, BYK-320, BYK-322, BYK-323, BYK-325 N, BYK-326, BYK-327, BYK-329, BYK-330, BYK-331, BYK-332, BYK-333, BYK-342, BYK-345, BYK-346, BYK-347, BYK-348, BYK-349, BYK-350, BYK-352, BYK-354, BYK-355, BYK-356, BYK-358 N, BYK-359, BYK-360 P, BYK-361 N, BYK-364 P, BYK-366 P, BYK-368 P, BYK 370, BYK 375, BYK-377, BYK-378, BYK-381, BYK-390, BYK-392, BYK-394, BYK-399, BYK-2616, BYK-3400, BYK-3410, BYK-3420, BYK-3450, BYK-3451, BYK-3455, BYK-3456, BYK-3480, BYK-3481, BYK-3499, BYK-3550, BYK-3560, BYK-3565, BYK-3566, BYK-3750, BYK-3751, BYK-3752, BYK-3753, BYK-3754, BYK-3760, BYK-3761, BYK-3762, BYK-3763, BYK-3764, BYK-3770, BYK-3771, BYK-3780, BYK-3900 P, BYK 3902 P, BYK-3931 P, BYK 3932 P, BYK-3933 P, BYK-8020, BYK-8070, BYK-9890, BYK-DYNWET 800, BYK-S 706, BYK-S 732, BYK-S 740, BYK-S 750 N, BYK-S 760, BYK-S 780, BYK-S 782, BYK-SILCELAN 3700, BYK-SILCLEAN 3701, BYK-SILCLEAN 3710, BYK-SILCLEAN 3720, BYK-UV 3500, BYK-UV 3505, BYK-UV 3510, BYK-UV 3530, BYK-UV 3535, BYK-UV 3570, BYK-UV 3575, BYK-UV 3576; BYKETOL series such as BYKETOL-AQ, BYKETOL-OK, BYKETOL-PC, BYKETOL-SPECIAL, BYKETOL-WA, NANOBYK series such as NANOBYK-3603, NANOBYK-3605, NANOBYK-3620, NANOBYK-3650, NANOBYK-3652, and NANOBYK-3822.

The wetting and dispersion agents used in the present invention are additives, which provide both wetting and/or stabilizing effects for formulations containing fine solid particles. They result in a fine and homogenous distribution of solid particles in a formulation media, preferably liquid formulation media, and ensure long-term stability of such systems. The formulation media may comprise water and the entire range of organic solvents of varying polarity. Moreover, they result in an improved wetting of solids and prevent particles from flocculating by various mechanisms (e. g. by electrostatic effects, steric effects, etc.).

Preferably, the wetting and dispersion agents are organic polymers or organic copolymers having polar functional groups selected from amino groups; amide groups; carbamate groups; carbonate groups; acidic groups, preferably boric acid groups, boronic acid groups, carboxylic acid groups, sulfuric acid groups, sulfonic acid groups, phosphoric acid groups, phosphonic acid groups, and phosphinic acid groups; ester groups, preferably boric ester groups, boronic ester groups, carboxylic ester groups, sulfuric ester groups, sulfonic ester groups, phosphoric ester groups, phosphonic ester groups, and phosphinic ester groups; ether groups; hydroxy groups; keto groups; and urea groups; wherein the organic polymers or copolymers may be present as a conjugate, derivative and/or salt, preferably as a salt. Preferred salts are ammonium salts, alkyl ammonium salts, alkylol ammonium salts, or alkaline metal salts such as preferably Li, Na, K and Rb salts. The polar functional groups may be also referred to as pigment-affinic groups or as filler-affinic groups. In a preferred embodiment, the wetting and dispersion agent is used as a solution.

More preferably, the wetting and dispersion agents are organic polymers or organic copolymers selected from acrylates; amides; carboxylic acids; and esters; wherein the organic polymers or copolymers may be present as a conjugate, derivative and/or salt, preferably as a salt; and wherein they may be further functionalized with one or more polar functional group as described above. Preferred salts are ammonium salts, alkyl ammonium salts, alkylol ammonium salts, or alkaline metal salts such as preferably Li, Na, K and Rb salts. In a preferred embodiment, the wetting and dispersion agent is used as a solution.

The wetting and dispersion agents may be present as a mixture, preferably as a mixture with a polysiloxane copolymer.

Preferred wetting and dispersing agents are commercially available from BYK-Chemie GmbH, Wesel, Germany. Preferred wetting and dispersing agents are ANTI-TERRA-202, ANTI-TERRA-203, ANTI-TERRA-204, ANTI-TERRA-205, ANTI-TERRA-210, ANTI-TERRA-250, ANTI-TERRA-U, ANTI-TERRA-U 80, ANTI-TERRA-U 100, BYK-151, BYK-153, BYK-154, BYK-155/35, BYK-156, BYK-220 S, BYK-1160, BYK-1162, BYK-1165, BYK-9076, BYK-9077, BYK-GO 8702, BYK-GO 8720, BYK-P 104, BYK-P 104 S, BYK-P 105, BYK-SYNERGIST 2100, BYK-SYNERGIST 2105, BYK-W 900, BYK-W 903, BYK-W 907, BYK-W 908, BYK-W 909, BYK-W 940, BYK-W 961, BYK-W 966, BYK-W 969, BYK-W 972, BYK-W 974, BYK-W 980, BYK-W 985, BYK-W 995, BYK-W 996, BYK-W 9010, BYK-W 9011, BYK-W 9012, BYKJET-9131, BYKJET-9132, BYKJET-9133, BYKJET-9142, BYKJET-9150, BYKJET-9151, BYKJET-9152, BYKJET-9170, BYKJET-9171, BYKUMEN, DISPERBYK, DISPERBYK-101 N, DISPERBYK-102, DISPERBYK-103, DISPERBYK-106, DISPERBYK-107, DISPERBYK-108, DISPERBYK-109, DISPERBYK-110, DISPERBYK-111, DISPERBYK-115, DISPERBYK-118, DISPERBYK-130, DISPERBYK-140, DISPERBYK-142, DISPERBYK-145, DISPERBYK-161, DISPERBYK-162, DISPERBYK-162 TF, DISPERBYK-163, DISPERBYK-163 TF, DISPERBYK-164, DISPERBYK-165, DISPERBYK-166, DISPERBYK-167, DISPERBYK-167 TF, DISPERBYK-168, DISPERBYK-168 TF, DISPERBYK-169, DISPERBYK-170, DISPERBYK-171, DISPERBYK-174, DISPERBYK-180, DISPERBYK-181, DISPERBYK-182, DISPERBYK-184, DISPERBYK-185, DISPERBYK-187, DISPERBYK-190, DISPERBYK-190 BF, DISPERBYK-191, DISPERBYK-192, DISPERBYK-193, DISPERBYK-194 N, DISPERBYK-199, DISPERBYK-199 BF, DISPERBYK-2000, DISPERBYK-2001, DISPERBYK-2008, DISPERBYK-2009, DISPERBYK-2010, DISPERBYK-2012, DISPERBYK-2013, DISPERBYK-2014, DISPERBYK-2015, DISPERBYK-2015 BF, DISPERBYK-2018, DISPERBYK-2019, DISPERBYK-2022, DISPERBYK-2023, DISPERBYK-2025, DISPERBYK-2026, DISPERBYK-2030, DISPERBYK-2050, DISPERBYK-2055, DISPERBYK-2059, DISPERBYK-2060, DISPERBYK-2061, DISPERBYK-2062, DISPERBYK-2070, DISPERBYK-2080, DISPERBYK-2081, DISPERBYK-2096, DISPERBYK-2117, DISPERBYK-2118, DISPERBYK-2150, DISPERBYK-2151, DISPERBYK-2152, DISPERBYK-2155, DISPERBYK-2155 TF, DISPERBYK-2157, DISPERBYK-2158, DISPERBYK-2159, DISPERBYK-2163, DISPERBYK-2163 TF, DISPERBYK-2164, DISPERBYK-2190, DISPERBYK-2200, DISPERBYK-2205, DISPERBYK-2290, DISPERBYK-2291, DISPERPLAST-1142, DISPERPLAST-1148, DISPERPLAST-1150, DISPERPLAST-1180, DISPERPLAST-I, and DISPERPLAST-P.

Preferred adhesion promoters are block copolymers, preferably high molecular weight block copolymers; copolymers with functional groups, preferably hydroxy-functional copolymers with acidic groups, styrene-ethylene/butylene-styrene block copolymer (SEBS) functionalized with maleic acid anhydride, carboxylated SEBS functionalized with maleic anhydride, SEBS functionalized with glycidyl methacrylate, polyolefin block copolymer functionalized with maleic acid anhydride, and ethylene octene copolymer functionalized with maleic anhydride; and polymers with functional groups, preferably polymers with acidic groups, and polypropylene functionalized with maleic anhydride. In a preferred embodiment, the adhesion promoter is used as a solution.

Preferred adhesion promoters are commercially available from BYK-Chemie GmbH, Wesel, Germany. Preferred adhesion promoters are BYK-4500, BYK-4509, BYK-4510, BYK-4511, BYK-4512, BYK-4513, SCONA TPKD 8102 PCC, SCONA TSIN 4013 GC, SCONA TSPOE 1002 GBLL, SCONA TPPP 2112 FA, SCONA TPPP 2112 GA, SCONA TPPP 8112 GA, SCONA TSKD 9103, SCONA TPPP 8112 FA, SCONA TPKD 8304 PCC, and SCONA TSPP 10213 GB.

Preferred polymer matrices are polymethyl methacrylate, polyvinylpyrrolidone, polycarbonate, polystyrene, polymethylpentene, and silicone.

It is particularly preferred that a combination of two or more of the above-mentioned additives are present in the formulation.

In a preferred embodiment of the present invention, the content of the additives in the formulation is from >0% to ≤10% (w/w), preferably >0.01% to <9% (w/w), more preferably >0.05% to <7.5% (w/w), and most preferably >0.1% to <5.0 (w/w), based on the total mass of the formulation.

In a preferred embodiment of the present invention, the formulation comprises one or more further metal halides, which may act as further metal oxide precursors. In such case, a mixed optical metal oxide layer may be formed comprising a metal oxide obtained from the metal halide compound and a further metal oxide obtained from the further metal oxide precursors.

Preferred further metal complexes comprise one or more trivalent or tetravalent metals, preferably selected from the list consisting of Sc, Y, La, Ti, Zr, Hf and Sn, more preferably one or more tetravalent metals selected from the list consisting of Ti, Zr, Hf and Sn.

In a preferred embodiment of the present invention, the formulation comprises one, two, three, four or more further metal complexes in addition to the metal halide compound, where preferably each of the further metal complexes contains ligands selected from inorganic ligands or organic ligands. Preferred inorganic ligands are halogenides, phosphoric acid, sulfonic acid, nitric acid and water, which are optionally deprotonated. Preferred organic ligands are alcohols, carboxylic acids, cyanates, isocyanates, 1,3-diketones, beta-keto acids, beta-keto esters, organylphosphonic acids, organylsulfonic acids, oximes, hydroxamic acids, dihydroxy benzenes, hydroxybenzoic acids, dihydroxy benzoic acids, gallic acid, dihydroxynaphthalenes, anthracene diols, hydroxy-anthrones, anthracene triols, dithranols, halogenated hydrocarbons, aromatics, heteroaromatics, esters, catechols, coumarins and their derivatives, which are optionally deprotonated.

The presence of such further metal complexes allows to adjust certain properties of the optical metal oxide layer prepared therefrom such as e. g. material hardness, shrinkage, refractive index, transparency, absorbance, and haze suppression.

Preferably, the mass ratio (w/w) between the metal halide compound and the one or more further metal complexes in the formulation is in the range from 1:100 to 100:1, preferably from 1:10 to 10:1, and more preferably from 1:5 to 5:1.

It is preferred that the total content of the metal halide compound and the further metal complexes contained in the formulation is in the range from 0.1% to 50% (w/w), preferably 0.5% to 40% (w/w), more preferably 1% to 30% (w/w), based on the total mass of the formulation.

In a preferred embodiment of the present invention, the formulation is an ink formulation suitable for inkjet printing. Typical requirements for ink formulations are surface tensions in the range from 20 mN/m to 30 mN/m and viscosities in the range from 5 mPa·s to 10 mPa·s.

### Use of the Formulation

In another aspect, the present invention also relates to use of the formulation of the present invention for preparing an optical layer containing a metal oxide, preferably for preparing a composite, more preferably for preparing a layered composite, preferably said optical layer contains a metal oxide halide. Namely for using the formulation as an ink for ink-jetting techniques.

In another aspect, the present invention relates to use of a formulation comprising at least one metal halide represented by any one of following formulae (I) to (V) as the 1^{st} metal halide; and at least one solvent; for preparing a composite in a process comprising at least the following steps (a) to (e), preferably in the sequence (a) to (e):
(a) providing a formulation onto a surface of a substrate, preferably by wet deposition process, more preferably by ink-jetting
(b) applying baking at a starting temperature to the formulation;
(c) increasing the temperature of the baking from the starting temperature to the 2^{nd} temperature in the range from 100° C. to 400° C.;
(d) optionally keeping the 2^{nd} temperature; and
(e) terminating the baking to obtain a composite, preferably by stopping heating, by removing the substrate from the heat source or by removing a heat source from the substrate;

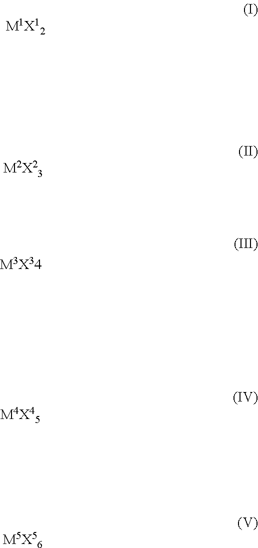

wherein M¹ is a divalent metal selected from Zn or Sn;
M² is a trivalent metal selected from Bi;
M³ is a quadrivalent metal selected from Ti, Zr or Hf;
M⁴ is a pentavalent metal selected from V, Nb or Ta;
M⁵ is Mo or W; and
X¹, X², X³, X⁴, X⁵, X⁶ are each independently a halogen, preferably X¹, X², X³, X⁴, X⁵, X⁶ are each independently selected from F, Cl, Br, I, more preferably X¹, X², X³, X⁴, X⁵, X⁶ are Cl;
wherein the solvent is an organic solvent.

Preferably said organic solvent is selected from one or more members of the group consisting of ethylene glycol monoalkyl ethers, preferably it is ethylene glycol monomethyl ether, ethylene glycol monoethyl ether, ethylene glycol monopropyl ether and/or ethylene glycol monobutyl ether; diethylene glycol dialkyl ethers, preferably it is diethylene glycol dimethyl ether, diethylene glycol diethyl ether, diethylene glycol dipropyl ether and/or diethylene glycol dibutyl ether; propylene glycol monoalkyl ethers, preferably it is propylene glycol monomethyl ether (PGME), propylene glycol monoethyl ether and/or propylene glycol monopropyl ether; ethylene glycol alkyl ether acetates, preferably it is methyl cellosolve acetate and/or ethyl cellosolve acetate; propylene glycol alkyl ether acetates, preferably it is propylene glycol monomethyl ether acetate (PGMEA), propylene glycol monoethyl ether acetate and/or propylene glycol monopropyl ether acetate; ketones, preferably it is methyl ethyl ketone, acetone, methyl amyl ketone, methyl isobutyl ketone and/or cyclohexanone; alcohols, preferably it is ethanol, propanol, 1,3-dimethoxy-2-propanol, butanol, hexanol, cyclo hexanol, ethylene glycol, propylene glycol, triethylene glycol, glycerin, pentanols, preferably it is 1-pentanol, 2-pentnol, 3-pentanol, 3-ethyl-3-pentanol, 2,4-dimethyl-3-pentanol; esters, preferably it is ethyl 3-ethoxypropionate, methyl 3-methoxypropionate and/or ethyl lactate; and cyclic esters, preferably it is gamma-butyro-lactone; preferably said solvent is selected from propylene glycol alkyl ether acetates, ethylene glycol monoalkyl ethers, propylene glycol and propylene glycol monoalkyl ethers, 1-pentanol, 2-pentnol, 3-pentanol, 3-ethyl-3-pentanol, 2,4-dimethyl-3-pentanol, 1,3-dimethoxy-2-propanol or a mixture of any one of them. Further preferably, said solvent contains at least 1,3-dimethoxy-2-propanol.

More details of the formulation and process details are described in the section of formulation and Method for preparing a composite containg a metal oxide.

### Method for Preparing a Composite Containing a Metal Oxide,

In another aspect, the present invention relates to a method for preparing a composite containing a metal oxide, preferably said metal oxide is selected from metal dioxide, metal mono oxide, or a combination of these; comprising the following steps (a^{x}) and (b^{x}):
(a^{x}) providing the formulation of any one of claims 1 to 5 onto a surface of a substrate, preferably by wet deposition process, more preferably by spin-coating or ink-jetting, even more preferably by ink-jetting; and
(b^{x}) applying a thermal treatment to the formulation provided on the surface of the substrate to convert at least a part of the metal halide of the formulation to a metal oxide.

Preferably said composite being a layered composite, more preferably said layered composite is an optical layer.

### Step (a^{x})

According to the present invention, the formulation may preferably be provided onto a surface of a substrate by wet deposition process. Said wet deposition process is drop casting, coating, or printing. A more preferred coating method is spin coating, spray coating, slit coating, or slot-die coating. A more preferred printing method is flexo printing, gravure printing, inkjet printing, EHD printing, offset printing, or screen printing. Furthermore, the preferred printing method is spray coating and inkjet printing and the most preferred one is inkjet printing.

Thus, in a preferred embodiment, the formulation is applied to a surface of a substrate by spin-coating or ink-jetting in step (a^{x}). From a viewpoint of cost effective, ink-jetting can preferably be used.

In a preferred embodiment of the present invention, the formulation provided in step (a^{x}) of the method is an ink formulation being suitable for inkjet printing. Typical requirements for ink formulations are surface tensions in the range from 20 mN/m to 30 mN/m and viscosities in the range from 5 mPas to 10 mPa·s.

Depending on the specific problem to be solved, the formulation needs to be deposited either as a homogeneous, dense and thin layer covering the entire surface of the substrate by a coating method or the formulation needs to be deposited locally in a structured manner, thus requiring for a printing method. Both, coating and printing methods require formulations to be formulated in an adequate manner to comply with the physico-chemical needs of the respective coating and printing method as well as to comply with certain needs regarding the surface of the substrate to be coated or printed.

In a preferred embodiment of the method of the present invention, the surface of the substrate is pre-treated by a surface cleaning process. Preferred surface cleaning processes are silicon wafer cleaning processes such as described in W. Kern, The Evolution of Silicon Wafer Cleaning Technology, J. Electrochem. Soc., Vol. 137, 6, 1990, 1887-1892 and in New Process Technologies for Microelectronics, RCA Review 1970, 31, 2, 185-454. Such silicon wafer cleaning processes include wet cleaning process involving cleaning solvents (e. g. isopropanol (IPA)); wet etching processes involving hydrogen peroxide solutions (e. g. piranha solution, SC1, and SC2), choline solutions, or HF solutions; dry etching processes involving chemical vapor etching, UV/ozone treatments or glow discharge techniques (e. g. O₂ plasma etching); and mechanical processes involving brush scrubbing, fluid jet or ultrasonic techniques (sonification). The surface of the substrate can also be pre-treated by silanization or an atomic layer deposition (ALD) process. The pre-treatment of the surface of the substrate serves to modify the hydrophobicity/hydrophilicity of the surface. This can improve the adhesion and filling characteristics of the optical metal oxide layer on the surface of the substrate.

In a more preferred embodiment, a wet cleaning process involving cleaning solvents (e.g. isopropanol (IPA)) is combined with one or more of a wet etching process involving hydrogen peroxide solutions (e.g. piranha solution, SC1, and SC2), choline solutions, or HF solutions; dry etching process involving chemical vapor etching, UV/ozone treatments or glow discharge techniques (e.g. O₂ plasma etching); and mechanical process involving brush scrubbing, fluid jet or ultrasonic techniques (sonification).

In a most preferred embodiment, a wet cleaning process involving cleaning solvents (e. g. isopropanol (IPA)) is combined with a mechanical process involving brush scrubbing, fluid jet or ultrasonic techniques (sonification) and with a wet etching process involving hydrogen peroxide solutions (e. g. piranha solution, SC1, and SC2), choline solutions, or HF solutions;

### Step (b^{x})

It is believed that the formulation, especially said metal halide precursor in the formulation is at least partly converted in step (b^{x}) on the surface of the substrate to a metal oxide to form a composite by exposure to thermal treatment. Said composite is preferably a layered composite. And said solvent is usually removed in step (b^{x}).

Preferred thermal treatment includes exposure to elevated temperature from 50 to 300° C., preferably it is from 80 to 250° C., more preferably from 100 to 200° C.

Thermal treatment is not limited to any specific thermal treatment methods or times. Depending on the type of substrate and formulation, a person skilled in the art can determine suitable thermal treatment methods

In some embodiments of the method for preparing an optical metal oxide layer according to the present invention, the formulation may be converted in step (b^{x}) on the surface of the substrate to an optical metal oxide layer by pre-baking (soft baking) at a temperature from 40 to 150° C., preferably from 50 to 120° C., more preferably from 60 to 100° C.; and then baking (hard baking, sintering or annealing) at a temperature from 150 to 600° C., preferably from 250 to 550° C., more preferably from 300 to 500° C.

Pre-baking (soft baking) serves the purpose of removing volatile and low boiling components such as e. g. volatile and low boiling formulation media or additives from the drop casted, coated or printed films. Pre-baking is preferably carried out for a period of 1 to 10 minutes. After pre-baking, layers of substrate adhering films of metal oxide precursor or metal oxide precursor mixtures are obtained. The films may still comprise residual formulation media or additives.

In an alternative preferred embodiment of the method for preparing an optical metal oxide layer according to the present invention, pre-baking can be omitted so that the formulation is converted in step (b^{x}) on the surface of the substrate to an optical metal oxide layer directly by baking (hard baking, sintering or annealing) at a temperature from 150 to 600° C., preferably from 150 to 500° C., more preferably from 150 to 300° C.

Baking (hard baking, sintering or annealing) serves the purpose of converting the metal oxide precursor or metal oxide precursor mixture layers on the substrate into a metal oxide layer. Moreover, the final properties of the metal oxide layer may be adjusted by the baking treatment. Baking is preferably carried out for a period of 1 to 300 minutes, preferably 1 to 60 minutes to achieve a refractive index (RI) of >1.7, preferably >1.8, more preferably >1.9, even more preferably >1.9, most preferably >2.0.

Pre-baking and baking may be carried out under ambient atmosphere or atmospheres with increased oxygen content to decompose unwanted organic components, which can lead to a lower activation energy when the metal oxide layers are formed.

The relative humidity of the atmosphere of the pre-baking and baking step should be controlled and should be between 10 and 90% relative humidity.

In a preferred embodiment of the method of present invention, the substrate is a patterned substrate comprising topographical features and the metal oxide forms a coating layer covering the surface of the substrate and filling said topographical features. As a result, the topographical features are filled and levelled by said metal oxide.

Preferred topographical features include, for example, gaps, grooves, trenches and vias. Topographical features may be distributed uniformly or non-uniformly over the surface of the substrate. Preferably, they are arranged as an array or grating on the surface of the substrate. It is preferred that the topographical features have different lengths, widths, diameters as well as different aspect ratios. It is preferred that said topographical features have an aspect ratio of 1:20 to 20:1, more preferably 1:10 to 10:1. The aspect ratio is defined as width of structure to its height (or depth). From the viewpoint of dimension, the depth of the topographical features is preferably in the range from 10 nm to 10 μm, more preferably 50 nm to 5 μm, and most preferably 100 nm to 1 μm.

It is also preferred that the topographical features are inclined at a certain angle, such as an angle from 10 to 80°, preferably from 20 to 60°, more preferably from 30 to 50°, most preferably about 40°. Such inclined topographical features are also referred to as slanted or blazed topographical features.

It may also be necessary to fill topographical features locally with optical metal oxide layer, either completely or to a certain level, but not to cover adjacent surfaces of the substrate, where no topographical features to be filled are available.

Hence, it is preferred that the method of the present invention further comprises the following step (c^{x}):
(c^{x}) removing a portion of said composite covering the top of the topographical features, thereby obtaining filled topographical features, wherein an overburden of the optical metal oxide layer on top of said topographical features is reduced, preferably to an overburden of between 0 to 100 nm, more preferably between 0 to 50 nm, and most preferably between 0 to 20 nm.

Step (c^{x}) takes place after steps (a^{x}) to (b^{x}) of the method according to the present invention. Preferably, removing a portion of said optical metal oxide layer covering a top of the topography in step (c^{x}) is performed by using a surface cleaning process as described above. Preferred surface cleaning processes are silicon wafer cleaning processes such as described in W. Kern, The Evolution of Silicon Wafer Cleaning Technology, J. Electrochem. Soc., Vol. 137, 6, 1990, 1887-1892 and in New Process Technologies for Microelectronics, RCA Review 1970, 31, 2, 185-454. Such silicon wafer cleaning processes include wet-etching processes involving hydrogen peroxide solutions (e. g. piranha solution, SC1, and SC2), choline solutions, or HF solutions; dry-etching processes involving chemical vapor etching, UV/ozone treatments or glow discharge techniques (e. g. O₂ plasma etching); and mechanical processes involving brush scrubbing, fluid jet or ultrasonic techniques.

The substrate is preferably a substrate of an optical device. Preferred substrates are made of inorganic or organic base materials, preferably inorganic base materials. Preferred inorganic base materials contain materials selected from the list consisting of ceramics, glass, fused silica, sapphire, silicon, silicon nitride, quartz, and transparent polymers or resins. The geometry of the substrate is not specifically limited, however, preferred are sheets or wafers.

In step (a^{x}) of the method, the formulation is applied on a surface of a substrate, wherein said surface may be either a surface of a base material of the substrate or a surface of a layer of a material being different from the base material of the substrate, wherein such layer has been formed prior to applying said formulation.

In this way, sequences of different layers (layer stacks) can be formed on top of one another. Such layer stacks may also be structured, wherein such structures typically have dimensions in the nanometer scale, at least with respect to diameter, width and/or aspect ratio.

### Composite

In another aspect, the present invention relates to a composite, preferably being a layered composite, preferably said layered composite is an optical layer, obtained or obtainable by the method of the present invention.

In a preferred embodiment of the present invention, the composite comprises at least a metal halide of formula (I); and a metal oxide derived from said metal halide

MX₂ (I);
wherein M is a divalent metal, preferably M is group 14 element of the periodic table, more preferably it is selected from Ge, Sn and Pb, furthermore preferably it is Sn; and
X is a halogen, preferably it is selected from F, Cl, Br, I, At, more preferably
X is Cl.

### Optical Device

The present invention relates to an optical device comprising the composite of the present invention, which is preferably obtainable or obtained by the method of the present invention as described above. It is preferred that the optical device is an augmented reality (AR) and/or virtual reality (VR) device. Preferably said composite fills gap of said topographical features, more preferably said composite fills trench of the patterned substrate.

Finally, the present invention relates to display device comprising at least one functional medium configured to modulate a light or configured to emit light; and the composite, or an optical device of the present invention.

### PREFERABLE EMBODIMENTS

1. Formulation for preparing an optical layer containing a metal oxide, preferably for preparing a composite, more preferably for preparing a layered composite, comprising
   (i) at least one metal halide as a precursor; and
   (ii) at least one solvent containing at least one hydroxy group, preferably the viscosity of the said solvent is 50 mPas or less, preferably the boiling point of the another solvent at 1 atm is 140° C. or more and 300° C. or less.
2. Formulation of embodiment 1, wherein said metal halide is represented by MX₂;
   wherein M is a divalent metal, preferably M is group 14 element of the periodic table, more preferably it is selected from Ge, Sn and Pb, furthermore preferably it is Sn; and
   X is a halogen, preferably it is selected from F, Cl, Br, I, At, more preferably X is Cl.
3. Formulation of embodiment 1 or 2, wherein the content of the metal halide in the formulation is in the range from 0.1% to 50% (w/w), based on the total mass of the formulation, preferably it is from 1 wt % to 25 wt %, more preferably from 5 to 15 wt %.
4. Formulation of any one of embodiments 1 to 3, said solvent is selected from alcohols, carboxylic acids, preferably it is selected from alcohols, more preferably it is methanol, Hydroxyacetone, 3,3-dimethyl-2-butanol, ethanol amine, cyclopentanol, 1,3-dimethoxy-2-propanol, diethyleneglycol monohexyl ether, dipropyleneglycol monobutyl ether, or a combination of any of these, even more preferably Hydroxyacetone, ethanol amine, cyclopentanol, 1,3-dimethoxy-2-propanol or a combination of any of these, furthermore preferably Hydroxyacetone or 1,3-dimethoxy-2-propanol.
5. Formulation according to any one of the preceding embodiments, wherein the formulation further comprises (iii) one or more additives selected from surfactants, wetting and dispersion agents, adhesion promoters, and polymer matrices.
6. Use of the formulation of any one of the preceding embodiments for preparing an optical layer containing a metal oxide, preferably for preparing a composite, more preferably for preparing a layered composite, preferably said optical layer contains a metal oxide halide.
7. Method for preparing a composite containing a metal oxide, preferably said metal oxide is selected from metal dioxide, metal mono oxide, or a combination of these; comprising the following steps (a) and (b):
   (a) providing the formulation of any one of embodiments 1 to 5 onto a surface of a substrate, preferably by wet deposition process, more preferably by spin-coating or ink-jetting, even more preferably by ink-jetting; and
   (b) applying a thermal treatment to the formulation provided on the surface of the substrate to convert at least a part of the metal halide of the formulation to a metal oxide.
   Preferably said composite being a layered composite, more preferably said layered composite is an optical layer.
8. Method according to embodiment 7, wherein in step (a) the formulation is applied to a surface of a substrate by spin-coating or ink-jetting.
9. Method according to embodiment 7 or 8, wherein in step (b) the formulation is at least partly converted on the surface of the substrate to a composite, preferably it is being of a layered composite, by baking it at a temperature from 50 to 300° C., preferably it is from 80 to 250° C., more preferably from 100 to 200° C.
10. Method according to one or more of embodiments 7 to 9, wherein the formulation is at least partly converted on the surface of the substrate to a composite, wherein said composite contains a metal oxide, preferably selected from dioxide and/or metal mono oxide; and a metal halide precursor.
11. Method according to one or more of embodiments 7 to 10, wherein the substrate is a patterned substrate comprising topographical features on the surface thereof.
12. A composite, preferably being a layered composite, preferably said layered composite is an optical layer, obtained or obtainable by the method of any one of embodiments 7 to 11.
13. The composite of embodiment 12, comprises at least a metal halide of formula (I); and a metal oxide derived from said metal halide

MX₂ (I);
wherein M is a divalent metal, preferably M is group 14 element of the periodic table, more preferably it is selected from Ge, Sn and Pb, furthermore preferably it is Sn; and
X is a halogen, preferably it is selected from F, Cl, Br, I, At, more preferably X is Cl.
14. An optical device comprising the composite of embodiment 12 or 13, and a patterned substrate comprising topographical features on the surface thereof. Preferably said composite fills gap of said topographical features, more preferably said composite fills trench of the patterned substrate.
15. A display device comprising at least one functional medium configured to modulate a light or configured to emit light; and the composite of embodiment 12 or 13, or an optical device of embodiment 14.

The present invention is further illustrated by the examples following hereinafter which shall in no way be construed as limiting. The skilled person will acknowledge that various modifications, additions and alternations may be made to the invention without departing from the spirit and scope of the invention as defined in the appended claims.

### EXAMPLES

### Analytics and Measurement Methods

SEM images are recorded using either a Mira 3 LMU from Tescan or Sigma 300VP from Carl Zeiss or Supra 35 from Carl Zeiss.

Substrate coating, usually wafers, is done using a spin coater (LabSpin 150i) from Suess. The spin coating process using planar substrates is as follows: deposition of 0.5 ml of the coating onto static quartz wafers followed by a spinning interval of 30 seconds at a given spin speed where the acceleration to reach the final spin speed is set to 500 rpm/s². Different layers and coating thicknesses are achieved using either different spin speeds or different coating formulations having different concentrations of the metal oxide precursor or mixtures of different metal oxide precursors. After spin coating, the coated substrates are subjected to thermal cure on a conventional lab hotplate. Usually, however not limited hereto, the coated layers are baked at 100° C. to 200° C. for between 1 to 10 minutes. Layer baking is performed using high temperature hotplates from Harry Gestigkeit allowing for reaching temperatures of up to 600° C. Afore-mentioned conditions and parameters apply to all following experimental examples unless other conditions are explicitly mentioned elsewhere.

As an alternative film preparation technique, inkjet printing was used. The formulations were filled into single-use cartridges (Dimatix Materials Cartridge with a nominal drop weight of 10 μL) and printed using a laboratory scale inkjet printing equipment (Dimatix Materials Printer DMP-2850 or a Pixdro LP50). The temperature of the printhead and the substrate holder were set to 30° C. Squares of approximately two by two cm were printed with varying resolutions to obtain different film thicknesses. After printing, the substrates were thermally dried and hard-baked at a temperature of 175° C. for five minutes. The center of the sqares shows a homogeneous material distribution and a flat film profile to allow for characterization of the thin film.

Usually, quartz and/or silicon wafers, both 2 inch in diameter, are used throughout all coating experiments where flat and non-structured carriers for metal oxides are required.

Ellipsometry measurements are made with spectrometer M2000 and evaluation of measurement data is done with software CompleteEase, both from J. A. Woolam. Spectroscopic measurements of specimen is done with the UV/Vis/NIR-spectrophotometer Cary 7000 from Agilent being equipped with UMA-setup.

All substrates, unless otherwise noted, were cleaned by immersion in 2-propanol and ultrasonication for ten minutes; successive immersion in deionized water and ultrasonication for ten minutes and drying on a hot plate at 100° C. for 10 minutes. Afterwards the substrates were treated in an oxygen plasma oven (450 watt, 5 minutes).

Structured substrates, usually silicon wafers, are used as square-shaped dies with edge lengths of 1.5 cm to 2 cm. The wafer dies are cut and cleaved from a parent wafer, typically having a diameter of 12 inch. The structures are created and arranged in a layer stack composed of SiO₂/SiNₓ deposited onto the wafer surface. Dimensions of the structures (e. g. cross-section width and length of trenches) referred to the architecture of Sematech mask 854. Usually, however not limited hereto, the cross-sectional cleaves perpendicular to trench arrays providing a width of 40 nm to 50 nm are used as trench structures of primary interest to investigate their filling behavior by the wet-chemically coated metal oxide precursors and/or metal oxides received upon thermal conversion of the said metal oxide precursors. Besides to aforementioned, cross-sections of arrays of trenches having widths of 100 nm and 150 nm are used to investigate trench filling by metal oxides, too.

Structured wafer dies are, unless otherwise mentioned, coated by spin coating. For that purpose, the coating formulation, typically a volume between 0.15 ml to 0.5 ml per die, is pipetted and casted onto wafer's surface. The formulation is allowed to spread and settle on the surface for one minute followed by a step of distributing and spreading of the formulation over the entire surface of the wafer die at 500 rpm for 30 seconds, followed by a final spin-off step at 2,000 rpm for further 60 seconds. The acceleration of the spin speed is set to 500 rpm/s². The soft bake and hard conditions of structured wafer dies is chosen similar or identical to those already mentioned for flat substrates.

All chemicals for synthesis described are purchased from Sigma Aldrich and used without further purification, unless differently mentioned elsewhere. 98% anhydrous SnCl₂ is used for the experiments described successively.

### Example 1

A formulation of 10% anhydrous SnCl₂ dissolved in methanol is made. A clear, transparent and colorless solution is achieved which became filtered using 0.2 μm syringe filter to remove any kind of particles and other suspended materials. The formulation is spun onto Si-wafers with 2000 rpm and the coated specimen are cured as mentioned above. The coatings on top of the Si-wafer are thick and showed a very inhomogeneous appearance, therefore the wafers are excluded from further optical characterization and analysis.

### Example 2

A formulation of 10% anhydrous SnCl₂ dissolved in PGME (propylene glycol monomethyl ether) is made. A turbid dispersion is achieved which became filtered using 0.2 μm syringe filter to remove the undissolved, suspended materials. After filtration, a precipitate formed during storage of the formulation overnight, so the formulation is excluded from further characterization and analysis.

### Example 3

A formulation of 10% anhydrous SnCl₂ dissolved in hydroxyacetone is made. A clear, transparent and colorless solution is achieved which became filtered using 0.2 μm syringe filter to remove any kind of particles and other suspended materials. The formulation is spun onto Si-wafers with 2,000 rpm and the coated specimen is cured as mentioned above. During its shelf life of 14 days at ambient conditions, the viscosity of the formulation increased recognizably until forming a highly viscous to jelly mixture, The color of the formulation changed from colorless to yellow-orange. This shelf-life of the mixture is too low and not suitably sufficient for industrial processing.

TABLE 1

| | | | | Normalized |
|---|---|---|---|---|
| Temperature | | Layer | | Absorption |
| [° C.] | Time [min] | Thickness [nm] | RI | [%/100 nm] |
| 100 | 1 | 101 | 1.764 | n. d. |
| 100 | 10 | 86 | 1.880 | n. d. |
| 150 | 5.5 | 63 | 2.013 | n. d. |
| 200 | 1 | 54 | 2.070 | n. d. |
| 200 | 10 | 53 | 2.102 | n. d. |

Table 1: Layer thickness, refractive indices and normalized absorptions of layers on Si-wafers derived from formulation 03 (acetol as solvent) and as function of curing conditions as curing temperature and duration of the cure.

### Example 4

A formulation of 10% anhydrous SnCl₂ dissolved in 3,3-dimethyl-2-butanol is made. A clear, transparent and colorless solution is achieved after filtration which turned into slightly opaque after a shelf-life of one day. The formulation is spun onto Si-wafers with 2,000 rpm and the coated specimen are cured as mentioned above. Due to changes in formulation's appearance, the storage stability is not sufficiently long enough.

TABLE 2

| | | | | Normalized |
|---|---|---|---|---|
| Temperature | | Layer | | Absorption |
| [° C.] | Time [min] | Thickness [nm] | RI | [%/100 nm] |
| 100 | 1 | 233 | 1.616 | n. d. |
| 100 | 10 | 249 | 1.603 | n. d. |
| 150 | 5.5 | 202 | 1.641 | n. d. |
| 200 | 1 | 159 | 1.681 | n. d. |
| 200 | 10 | 140 | 1.673 | n. d. |

Table 2: Layer thickness, refractive indices and normalized absorptions of layers on Si-wafers derived from formulation 04 (3,3-dimethyl-2-butanol as solvent) and as function of curing conditions as curing temperature and duration of the cure.

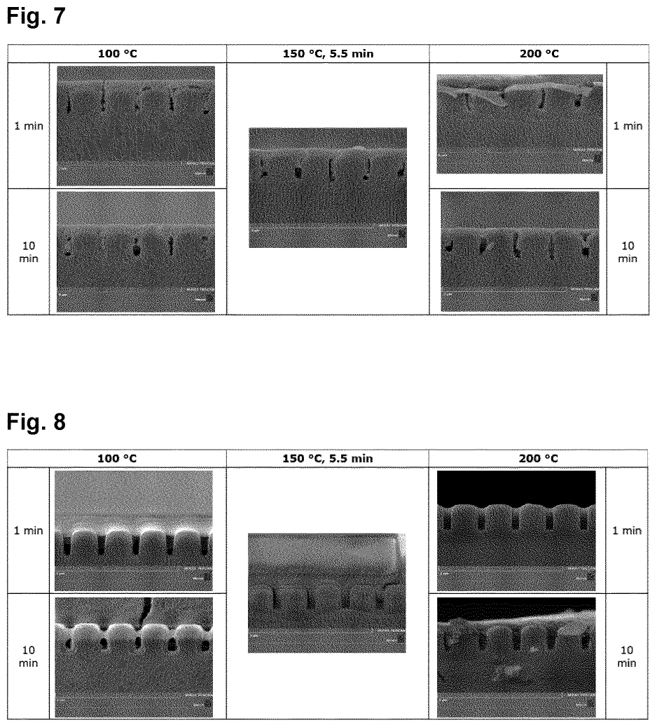

FIG. 7: Gap and trench fill using pre-structured Si-wafers and the formulation from example 04, 3,3-dimethyl-2-butanol as solvent. The nominal cross-sectional opening width of the trenches is 150 nm. None of the trenches showed complete and homogeneous gap fill, regardless of the curing applied.

### Example 5

A formulation of 10% anhydrous SnCl₂ dissolved in ethanol amine is made. A clear, transparent and colorless solution is achieved. Prior to spin coating, the formulation is filtered through 0.2 μm syringe filter, the formulation is spun onto Si-wafers with 2,000 rpm and the coated specimen are cured as mentioned above. Due to changes in formulation's appearance, the storage stability is not sufficiently long enough.

TABLE 3

| | | | | Normalized |
|---|---|---|---|---|
| Temperature | | Layer | | Absorption |
| [° C.] | Time [min] | Thickness [nm] | RI | [%/100 nm] |
| 100 | 1 | n. d. | n. d. | n. d. |
| 100 | 10 | 556 | 1.588 | n. d. |
| 150 | 5.5 | 255 | 1.747 | n. d. |
| 200 | 1 | 469 | 1.569 | n. d. |
| 200 | 10 | n. d. | n. d. | n. d. |

Table 3: Layer thickness, refractive indices and normalized absorptions of layers on Si-wafers derived from formulation 05 (ethanol amine as solvent) and as function of curing conditions as curing temperature and duration of the cure.

FIG. 8: Gap and trench fill using pre-structured Si-wafers and the formulation from example 05, ethanol amine as solvent. The nominal cross-sectional opening width of the trenches is 150 nm. Most trenches revealed gap fill issues either due to incomplete fill up of structures or crack and void formation.

### Example 6

A formulation of 10% anhydrous SnCl₂ dissolved in cyclopentanol is made. After filtration using a 0.2 μm syringe filter, a still slightly turbid, however, colorless mixture is achieved. The formulation is spun onto Si-wafers with 2,000 rpm and the coated specimen are cured as mentioned above.

TABLE 5

| | | | | Normalized |
|---|---|---|---|---|
| Temperature | | Layer | | Absorption |
| [° C.] | Time [min] | Thickness [nm] | RI | [%/100 nm] |
| 100 | 1 | 110 | 1.829 | n. d. |
| 100 | 10 | 109 | 1.758 | n. d. |
| 150 | 5.5 | 112 | 1.726 | n. d. |
| 200 | 1 | 108 | 1.736 | n. d. |
| 200 | 10 | 77 | 1.854 | n. d. |

Table 5: Layer thickness, refractive indices and normalized absorptions of layers on Si-wafers derived from formulation 06 (cyclopentanol as solvent) and as function of curing conditions as curing temperature and duration of the cure.

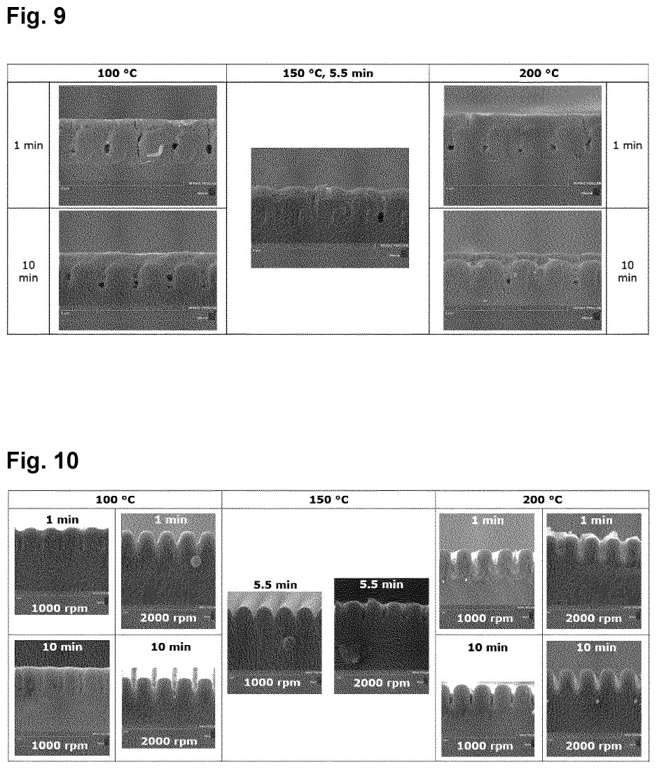

FIG. 9: Gap and trench fill using pre-structured Si-wafers and the formulation from example 06, cyclopentanol as solvent. The nominal cross-sectional opening width of the trenches is 150 nm. Most trenches revealed gap fill issues either due to incomplete fill up of structures or crack and void formation.

### Example 7

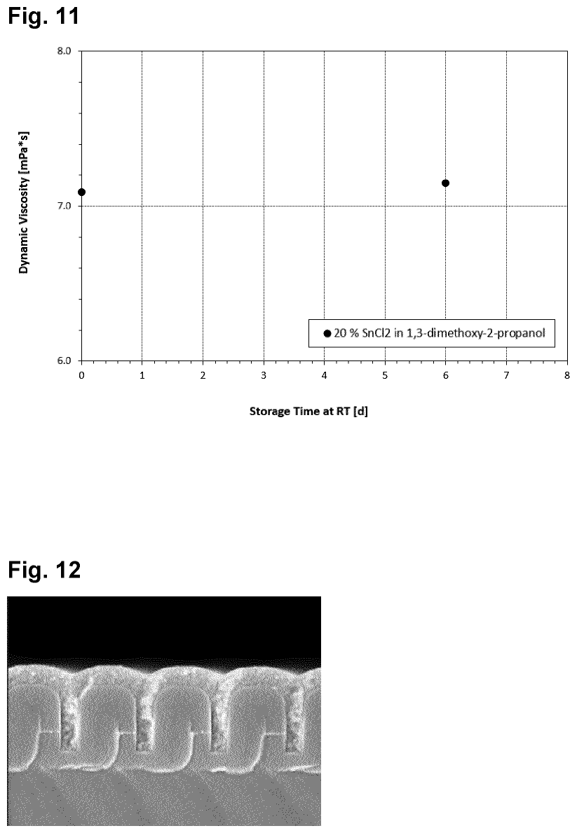

A formulation of 10% anhydrous SnCl₂ dissolved in 1,3-dimethoxy-2-propanol is made. After filtration of the formulation using a 0.2 μm syringe filter, a clear, transparent and colorless solution is obtained which is stable over a long period. The formulation is spun onto Si-wafers with 2000 rpm and the coated specimen are cured as mentioned above. During a similar experiment, the dynamic viscosity of a 20% w/w formulation of SnCl₂*2 H₂O dissolved in 1,3-dimethoxy-2-propanol is monitored over a storage period of 6 days of storing the formulation at room temperature. The viscosity is determined using a capillary ball viscosimeter. The viscosity measurements are: 7.09 mPa*s at the beginning of the observation period and 7.14 mPa* after the above-mentioned storage time of 7 days (cf. Figure FIG. 11). The difference in viscosities is 0.8%. Thus, the relative change of measurement data stayed within the range of the reproducibility of viscosity measurements which is ±1%. The formulation is considered as stable.

TABLE 6

| | | | | Normalized |
|---|---|---|---|---|
| Temperature | | Layer | | Absorption |
| [° C.] | Time [min] | Thickness [nm] | RI | [%/100 nm] |
| 100 | 1 | 136 | 1.502 | n. d. |
| 100 | 10 | 116 | 1.541 | n. d. |
| 150 | 5.5 | 94 | 1.631 | n. d. |
| 200 | 1 | 40 | 1.969 | n. d. |
| 200 | 10 | 40 | 2.002 | n. d. |

Table 6: Layer thickness, refractive indices and normalized absorptions of layers on Si-wafers derived from formulation 07 (1,3-dimethoxy-2-propanol as solvent) and as function of curing conditions as curing temperature and duration of the cure.

FIG. 10: Gap and trench fill using pre-structured Si-wafers and the formulation from example 07, 1,3-dimethoxy-2-propanol as solvent. The nominal cross-sectional opening width of the trenches is 150 nm. Most trenches revealed complete gap fill whereby in some other instances, wetting of the wafers is incomplete which led to partial gap fill only.

FIG. 12: Si wafer coated with formulation from example 07, 1,3-dimethoxy-2-propanol as solvent, and subsequently cured at 100° C. for 1 minute, at 100° C. for 10 minutes, at 150° C. for 5.5 minutes, at 200° C. for 1 minute as well as at 200° C. for 10 minutes, wafer images from left to right respectively. The wafers revealed quite homogeneously coated & cured layers.

### Example 8

A formulation of 10% anhydrous SnCl₂ dissolved in diethyleneglycol monohexyl ether is made. After filtration of the formulation using a 0.2 μm syringe filter, a clear, transparent and colorless solution is obtained which is stable over a long period. The formulation is spun onto Si-wafers with 2000 rpm, but the formulation does not wet the surfaces of the wafers properly and therefore no wet film is deposited onto the wafer surfaces. To improve the surface wettability, wafer surfaces are coated with HMDS (hexamethyl disilazane) and subsequently cured at 100° C. for 5 min. The wafer surfaces are rendered completely hydrophobically. The hydrophobically modified wafers are coated using the SnCl₂ formulation again. However, also under these circumstances the wafer surfaces does not became properly wetted and film deposition is incomplete.

### Example 9

A formulation of 10% anhydrous SnCl₂ dissolved in dipropyleneglycol monobutyl ether is made. After filtration of the formulation using a 0.2 μm syringe filter, a clear, transparent and colorless solution is obtained which is stable over a long period. The formulation is spun onto Si-wafers with 2000 rpm, but the formulation does not wet the surfaces of the wafers properly and therefore no wet film is deposited onto the wafer surfaces. To improve the surface wettability, wafer surfaces are coated with HMDS (hexamethyl disilazane) and subsequently cured at 100° C. for 5 min. The wafer surfaces are rendered completely hydrophobically. The hydrophobically modified wafers are coated using the SnCl₂ formulation again. However, also under these circumstances the wafer surfaces does not became properly wetted and film deposition is incomplete.

### Synopsis of Individual Results:

The most important results from all formulation evaluation experiments are summarized and compiled in table 7. The sum or a score of all individual test results referring to one formulation is established where positive test results, indicated in the table by “yes”, are summed up to the total number of positive test results. The formulation with highest score is the one being best suited to be used as for formulating SnCl₂. The use of 1,3-dimethoxy-2-propanol as formulation solvent has proven to reach sufficiently high RI-values, exceeding 1.7 at a wavelength of 520 nm and approaching the level of 2.0 or even exceeding it. Furthermore, the 1,3-dimethoxy-2-propanol formulation of SnCl₂ served with an acceptable gap fill capability providing densely and crack-free fill up of cavities and trenches.

TABLE 7

| | | Stability of | Coating | | | Gap | Rating/ |
|---|---|---|---|---|---|---|---|
| Formulation | Solvent | Formulation | Homogeneity | RI ≥1.7 | RI ≥2.0 | fill | Score |
| Example 1 | Methanol | yes | no | no | no | no | + |
| Example 3 | Hydroxyacetone | no | yes | yes | yes | yes | 4+ |
| Example 4 | 3,3-dimethyl-2- | no | yes | no | no | no | + |
| | butanol | | | | | | |
| Example 5 | Ethanol amine | yes | no | yes | no | no | 2+ |
| Example 6 | Cyclopentanol | no | yes | yes | no | no | 2+ |
| Example 7 | 1,3-dimethoxy-2- | yes | yes | yes | yes | yes | 5+ |
| | proanol | | | | | | |
| Example 8 | Diethyleneglycol | yes | no | no | no | no | + |
| | monohexyl ether | | | | | | |
| Example 9 | Dipropyleneglycol | yes | no | no | no | no | + |
| | monobutyl ether | | | | | | |

### Example 10

1.01 g of SnCl₂ dihydrate (CAS-Nr. 10025-69-1, Supelco) is dissolved in a blend of Propylene glycol monomethyl ether (PGME), 1,3-Dimethoxy-2-propanol (1,3-DM2P) and Diethylene glycol (DEG) (1.09 g, 2.67 g and 0.25 g respectively) by stirring at room temperature to yield a formulation with 20 wt % solid content, a PGME content of 21.7 wt %, 53.3 wt % of 1,3-DM2P and 5 wt % of DEG. The clear, colorless formulation is filtered and transferred to a printing cartridge. A series of squares is printed with droplet spacing in x- and y-direction of 35 μm, 40 μm and 45 μm. The resulting wet film is dried at 175° C. for 5 minutes and a film thickness between 100 and 200 nm is obtained, the refractive index is summarized in the following table. Also the shape retention and the homogeneity of the printed square is judged and summarized in the table below.

| Layer | | Shape retention and |
|---|---|---|
| Thickness [nm] | RI | homogeneity |
| 198 | 1.7355 | 0 |
| 143 | 1.7355 | 2+ |
| 112 | 1.7355 | + |

FIG. 12: Si wafer coated with formulation from example 10. The wafer is best homogeneously coated by the formulation & homogeneously cured layer is obtained.

### Example 11

1.00 g of SnCl₂ dihydrate (CAS-Nr. 10025-69-1, Supelco) is dissolved in a blend of Propylene glycol monomethyl ether (PGME) and 1,3-Dimethoxy-2-propanol (1,3-DM2P) (1.17 g and 2.84 g respectively) by stirring at room temperature to yield a formulation with 20 wt % solid content, a PGME content of 23.1 wt % and 56.9 wt % of 1,3-DM2P. The clear, colorless formulation is filtered and transferred to a printing cartridge. A series of squares is printed with droplet spacing in x- and y-direction of 30 μm, 35 μm, 40 μm, 45 μm and 50 μm. The resulting wet film is dried at 175° C. for 5 minutes and a film thickness between 50 and 150 nm is obtained, the refractive index is summarized in the following table.

| Layer | | Shape retention and |
|---|---|---|
| Thickness [nm] | RI | homogeneity |
| 152 | 1.7324 | 0 |
| 124 | 1.7283 | 2+ |
| 72 | 1.8179 | + |
| 61 | 1.7736 | + |
| 42 | 1.8123 | + |

### Example 12

3 g SnCl₂*2H₂O (Cas-No: 10025-69-1), 3.25 g PGME (Cas-No: 107-98-2), 0.75 g of DEG (Cas-No: 111-46-6) and 8 g of 13DM2P (1,3-Dimethoxy-2-propanol) (Cas-No: 623-69-8) are used.

First, 3 g SnCl₂*2H₂O is dissolved in PGME and DEG mixture for 1.5 h while stirring at room temperature. Then, 13DM2P is added and stirred for another 0.5 h at room temperature. Finally yielding a 20 wt % solution of SnCl₂ in PGME and DEG. Before using the formulation for inkjet printing, obtained formulation is filtered with a 400 μm PTFE Filter. Then, formulation A is obtained.

The standard cleaning procedure for a substrate is applied to silicon & quarts wafers having 150 nm width trenches. Said cleaning comprises 10 min ultrasonic bath treatment in IPA, followed by rinsing with DI water, followed by drying at 100° C. on a hotplate, followed by a 5 min oxygen plasma treatment.

Then, the obtained formulation A is printed onto a cleaned silicon & quarts wafers. After printing the formulation A on silicon and quartz wafers, the wafers are immediately put on a heating plate for 5 min in ambient environment. Different temperature conditions (165° C., 180° C., 195° C., 210° C., and 225° C. for 5 min) are applied.

The temperature ramp is also done by putting the wafer on the 165° C. heater plate and increasing the temperature to 225° C. over the course of 4.5 min (rate ~13.3° C./min).

Ellipsometry and absorption measurement are carried out to determine the refractive index and the absorption, while gap fill properties are investigated using standard trenched wafers with trench width of ~40, ~90, and ~140 nm width. Following table shows the results.

| | | | | | | |
|---|---|---|---|---|---|---|
| Heating temperature | 165° C. | 180° C. | 195° C. | 210° C. | 225° C. | Temperature ramp up |
| | | | | | | 165° C.-225° C. |
| RI value | 1.75 | 1.75 | 1.81 | 1.9 | 1.95 | 2.1 |
| Defects/Trench number | 0 | 0 | 8/75 | 23/75 | 31/75 | 0 |
| Qualitative | good | good | mediocre | mediocre | mediocre | good |

### Example 13

From the view point of using less teratogenic material, tripropylene glycol (TPG) is more preferable one for this invention to use it in the formulation instead of DEG.

Thus, Formulation B is prepared in the same manner as described in Example 12 except for that TPG is used instead of DEG.

Then, Example 13 is carried out in the same manner as described in Example 12 except for that Formulation B is used instead of Formulation A.

When heating temperature 175-180° C. is appiled to TPG containing formulation B printed onto the cleaned silicon and quartz wafer, as the results, flawless and totally no defects gapfill with showing low absorption (<0.2%/100 nm) and around 1.75 refractive index (RI) value (identical RI value to DEG containing formulation A) are obtained.

By changing the layer thickness of obtained metal oxide layer (made from Formulation B) fabricated onto the silicon & quarts wafers, from 75 nm to 200 nm, other samples are fabricated and same measurements are applied to these samples. Then, same results are obtained.

When heating temperature 225° C. is applied to TPG containing formulation B printed onto the cleaned silicon and quartz wafer, as the results, low absorption (<0.2%/100 nm) and the refractive index (RI) value 1.95 (identical RI value to DEG containing formulation A) are obtained. Gap-fill property is similar to the results of Formulation A of example 12.

By changing the layer thickness of obtained metal oxide layer (made from Formulation B) fabricated onto the silicon & quarts wafers, from 75 nm to 200 nm, other samples are fabricated and same measurements are applied to these samples. Then, same results are obtained.

In case of Temperature ramp-up from 165° C. as the initial stating temperature of heating to 225° C. is applied, defect formation within a film and within the trenches of the silicon & quartz wafer is well suppressed, and good gap-filled metal oxide layer is obtained. The obtained layer also showed improved RI value with low absorption like working example 12 (Formulation A).

1. Method for preparing a composite, comprising at least the following steps (a) to (e):
(a) providing a formulation onto a surface of a substrate to prepare a coated substrate;
(b) applying baking at a starting temperature to the coated substrate;
(c) increasing the temperature of the baking from the starting temperature to a 2nd temperature in the range from 100° C. to 400° C.;
(d) optionally keeping the 2nd temperature; and
(e) terminating the baking to obtain a composite;
wherein said formulation provided in step (a) contains at least one metal halide represented by any one of following formulae (I) to (V) as a 1st metal halide; and at least one solvent: 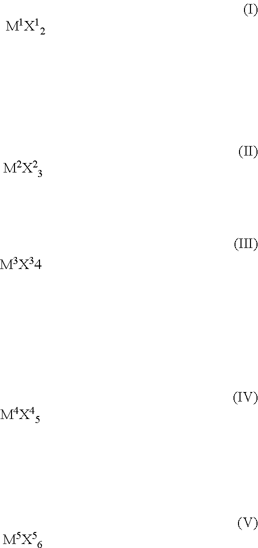
wherein M¹ is a divalent metal selected from Zn or Sn;
M² is a trivalent metal selected from Bi;
M³ is a quadrivalent metal selected from Ti, Zr or Hf;
M⁴ is a pentavalent metal selected from V, Nb or Ta;
M⁵ is Mo or W; and
X¹, X², X³, X⁴, X⁵, and X⁶ are each independently a halogen.

2. Method of claim 1, wherein the formulation further contains another metal halide as a 2^{nd} metal halide represented by any one of the formulae (I′) to (V′): 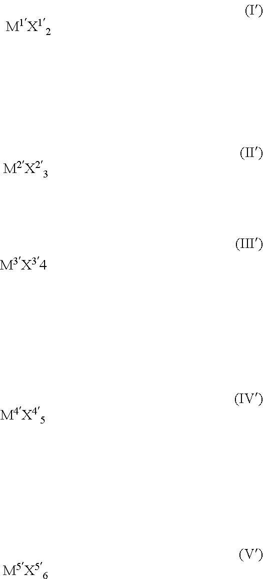
wherein M¹′ is a divalent metal;
M²′ is a trivalent metal selected from Bi;
M³′ is a quadrivalent metal selected from Ti, Zr or Hf;
M⁴′ is a pentavalent metal selected from V, Nb or Ta;
M⁵′ is Mo or W; and
X¹′, X²′, X³′, X⁴′, X⁵′, and X⁶′ are each independently a halogen; and
said 1^{st} metal halide and the 2^{nd} metal halide are different of each other; and
the weight ratio of the 2^{nd} metal halide to the 1^{st} metal halide is less than 1.

3. Method of claim 1, wherein the total content of all metal halide(s) in the formulation is in the range from 0.1 w % to 50 w % based on the total mass of the formulation.

4. Method of claim 1, wherein the solvent is an organic solvent.

5. Method of claim 1, wherein the solvent contains at least 1,3-dimethoxy-2-propanol.

6. Method of claim 1, wherein the metal halide of the formulation is represented by formula (I) and the solvent contains at least 1,3-dimethoxy-2-propanol.

7. Method of claim 1, wherein the starting temperature of step (b) is in the range from 20° C. to 300° C.

8. Method of claim 1, wherein the temperature of the baking in step (c) is increased to the temperature in the range from 100° C. to 400° C.

9. Method of claim 1, wherein the temperature of the bake in step (c) is increased at the temperature increasing rate in the range from 1° C./min to 20° C./min.

10. Method of claim 1, wherein the substrate has a patterned surface or an uneven surface having a gap or a trench.

11. A composite obtained or obtainable by the method of claim 1.

12. The composite of claim 11, comprising at least one metal halide, and a metal oxide derived from said metal halide.

13. An optical device comprising the composite of claim 11 and a substrate comprising a patterned surface or an uneven surface having a gap or a trench.

14. A display device comprising at least one functional medium configured to direct and modulate light or configured to emit light; and the composite of claim 11.

15. (canceled)

16. Method of claim 1, wherein said composite is a layered composite.

17. Method of claim 1, wherein said composite is an optical layer.

18. Method of claim 1, wherein the coated substrate is prepared by a wet deposition process.

19. Method of claim 1, wherein the coated substrate is prepared by ink-jetting the formulation.

20. Method of claim 1, wherein X¹, X², X³, X⁴, X⁵, and X⁶ are each independently selected from F, Cl, Br, and I.

21. Method of claim 1, wherein X¹, X², X³, X⁴, X⁵, and X⁶ are Cl.
